(19) United States
(12) Patent Application Publication
(10) Pub. No.: US 2026/0169763 A1
(43) Pub. Date: Jun. 18, 2026

(54) APPLICATION-BASED CLIPBOARD ISOLATION AND SHARING

(71) Applicant: CITRIX SYSTEMS, INC., Fort Lauderdale, FL (US)

(72) Inventors: PENG YAO, NANJING (CN); LEI ZHOU, NANJING (CN); TIANYU XIAO, NANJING (CN)

(21) Appl. No.: 18/859,604

(22) PCT Filed: Aug. 31, 2022
(86) PCT No.: PCT/CN2022/116025

§ 371 Date: Oct. 24, 2024

(51) Int. Cl. G06F 9/451; G06F 3/04845

(52) U.S. Cl. CPC G06F 9/451; G06F 3/04845

(57) ABSTRACT

In accordance with one disclosed method, a first application (A) determines that a first operating system received a first input indicating that first data of a second application is to be copied to a first clipboard associated with the first operating system, (B) determines that the second application is associated with a second clipboard, (C) instructs the first operating system to refrain from transferring the first data to the first clipboard, (D) receives the first data from the first operating system, and (E) transfers the first data to the second clipboard.

### BACKGROUND

Various systems have been developed that allow client devices to access applications and/or data files over a network. Certain products offered by Citrix Systems, Inc., of Fort Lauderdale, Florida, including the Citrix Workspace™ family of products, provide such capabilities.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method involves determining, by a first application, that a first operating system received a first input indicating that first data of a second application is to be copied to a first clipboard associated with the first operating system; determining, by the first application, that the second application is associated with a second clipboard; instructing, by the first application, the first operating system to refrain from transferring the first data to the first clipboard; receiving, by the first application, the first data from the first operating system; and transferring, by the first application, the first data to the second clipboard.

In some embodiments, a method involves determining, by a first application, that that an operating system received a first input indicating that first data is to be pasted from a first clipboard associated with the operating system to a second application which has been given focus; determining, by the first application, that the second application is associated with a second clipboard, the second clipboard including second data; instructing, by the first application, the operating system to refrain from transferring the first data from the first clipboard to the second application; retrieving, by the first application, the second data from the second clipboard; and instructing, by the first application, the operating system to transfer the second data to the second application.

In some embodiments, a first computing system includes at least one first processor, and at least one first computer-readable medium encoded with instructions which, when executed by the at least one first processor, cause the first computing system to determine, by a first application, that a first operating system received a first input indicating that first data of a second application is to be copied to a first clipboard associated with the first operating system, to determine, by the first application, that the second application is associated with a second clipboard, to instruct, by the first application, the first operating system to refrain from transferring the first data to the first clipboard, to receive, by the first application, the first data from the first operating system, and to transfer, by the first application, the first data to the second clipboard.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIGS. 1A and 1B illustrate a first example implementation of a system for providing isolated clipboard regions for particular applications and/or groups of applications in accordance with some embodiments of the present disclosure;

FIG. 1C illustrates how private clipboards in different computing environments can be synchronized in accordance with some embodiments of the present disclosure;

FIG. 2 is a diagram of a network environment in which some embodiments of the systems and techniques disclosed herein may deployed;

FIG. 3 is a block diagram of a computing system that may be used to implement one or more of the components of the computing environment shown in FIG. 2 in accordance with some embodiments;

FIG. 4A is a block diagram of an example system in which resource management services may manage and streamline access by clients to resource feeds (via one or more gateway services) and/or software-as-a-service (SaaS) applications;

FIG. 4B is a block diagram showing an example implementation of the system shown in FIG. 4A in which various resource management services as well as a gateway service are located within a cloud computing environment;

FIG. 5A is a block diagram illustrating key components of a resource delivery system which may be useful for practicing embodiments described herein;

FIG. 5B illustrates an example deployment of a resource delivery system such as that shown in FIG. 5A;

FIG. 5C illustrates an example process for handling user connections within the deployment shown in FIG. 5B;

FIG. 5D shows examples of paths through which the resource manager and the resource monitor shown in FIG. 5B may access stored data;

FIG. 5E illustrates a simple layout of a resource delivery system in which tag restrictions may be used to limit which machines will be considered for certain desktop and application launches;

FIG. 5F is a block diagram of a resource delivery system similar to the shown in FIG. 5A but in which several elements are provided as a service within a cloud-based computing environment;

FIG. 6 depicts an example virtualized (hypervisor) system architecture that may be used in accordance with one or more embodiments described herein;

FIG. 7 illustrates a first example routine that may be performed by an application in a scenario in which an operating system receives a request to copy data from another application to a clipboard;

FIG. 8 illustrates a second example routine that may be performed by an application in a scenario in which an operating system receives a request to copy data from a clipboard to another application;

FIG. 9A illustrates a first example code module that may be executed by the clipboard management engine shown in FIGS. 1A and 1B and/or the first application shown in FIGS. 7 and 8;

FIG. 9A illustrates a second example code module that may be executed by the clipboard management engine shown in FIGS. 1A and 1B and/or the first application shown in FIGS. 7 and 8;

FIG. 10A illustrates a third example code module that may be executed by the clipboard management engine shown in FIGS. 1A and 1B and/or the first application shown in FIGS. 7 and 8; and

FIG. 10B illustrates a fourth example code module that may be executed by the clipboard management engine shown in FIGS. 1A and 1B and/or the first application shown in FIGS. 7 and 8.

### DETAILED DESCRIPTION

For purposes of reading the description of the various embodiments below, the following descriptions of the sections of the specification and their respective contents may be helpful:
Section A provides an introduction to example embodiments of a system for providing isolated clipboard regions for particular applications and/or groups of applications;
Section B describes a network environment which may be useful for practicing embodiments described herein;
Section C describes a computing system which may be useful for practicing embodiments described herein;
Section D describes embodiments of systems and methods for managing and streamlining access by clients to a variety of resources;
Section E describes an example implementation of a resource delivery system which may be useful for practicing embodiments described herein;
Section F describes an example architecture of a resource virtualization server;
Section G provides a more detailed description of example embodiments of the system for providing isolated clipboard regions for particular applications and/or groups of applications introduced in Section A; and
Section H describes example implementations of methods, systems/devices, and computer-readable media in accordance with the present disclosure.

### A. Introduction to Illustrative Embodiments of a System for Providing Isolated Clipboard Regions for Particular Applications and/or Groups of Applications

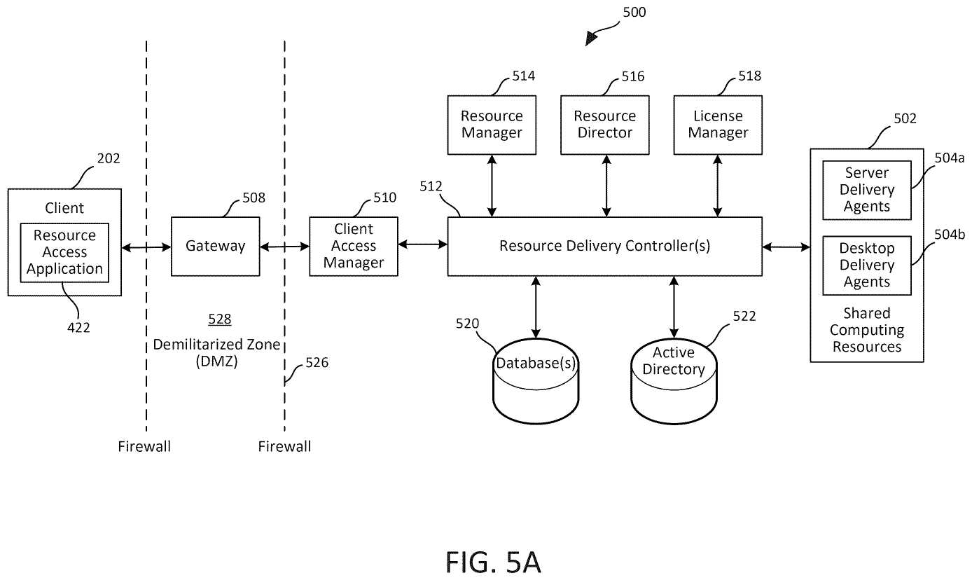

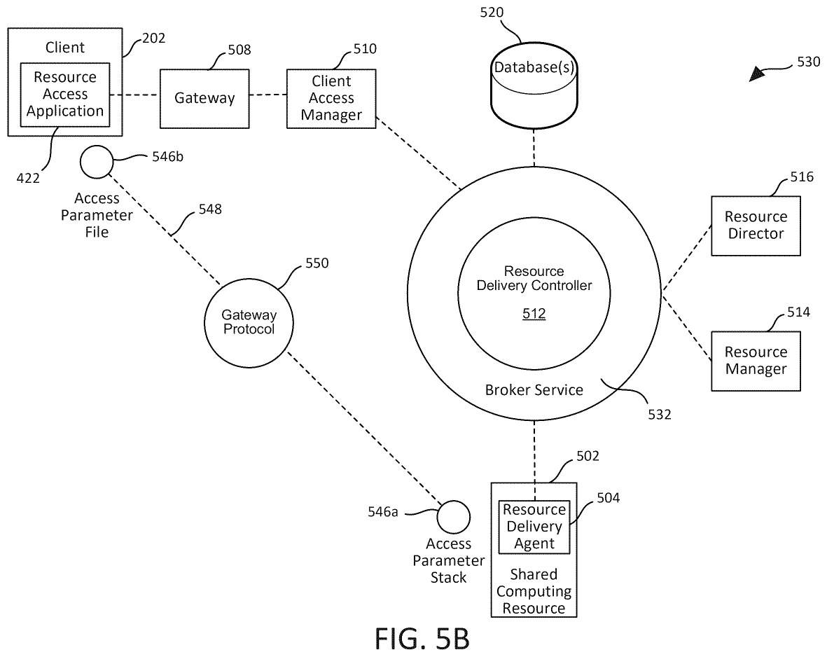

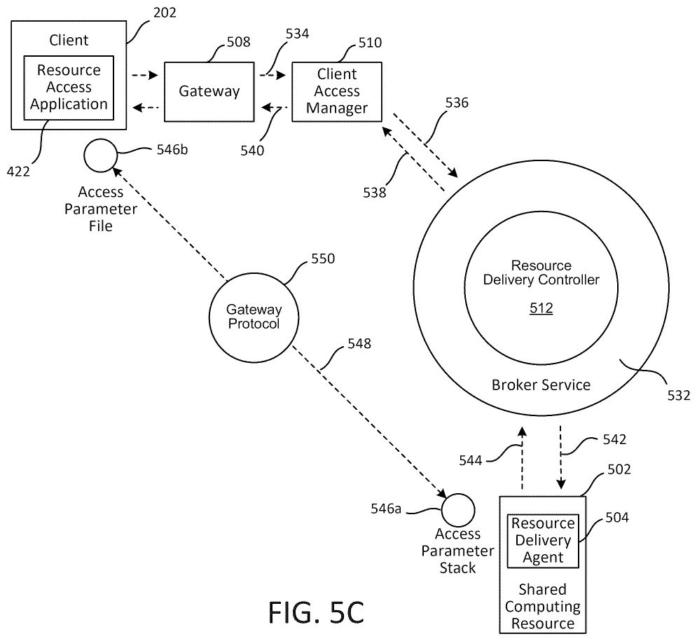

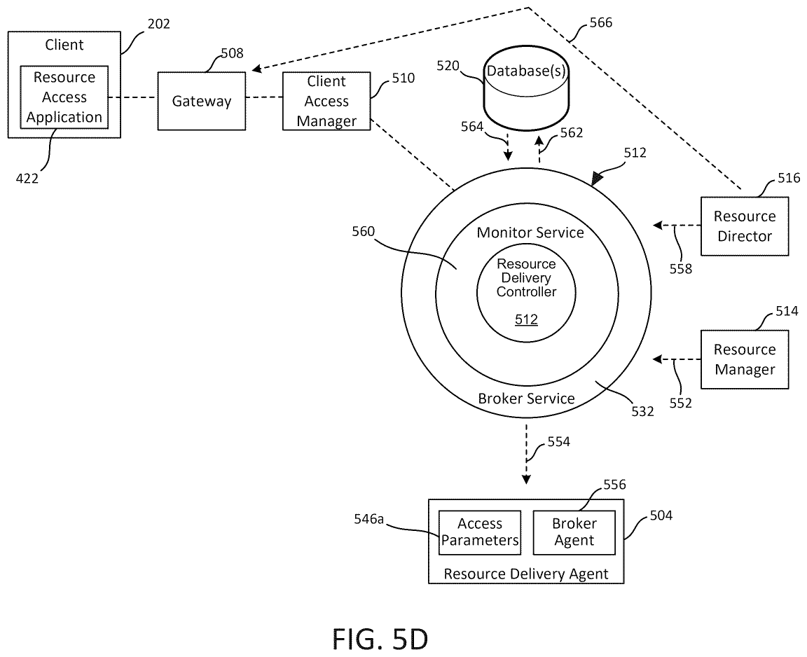

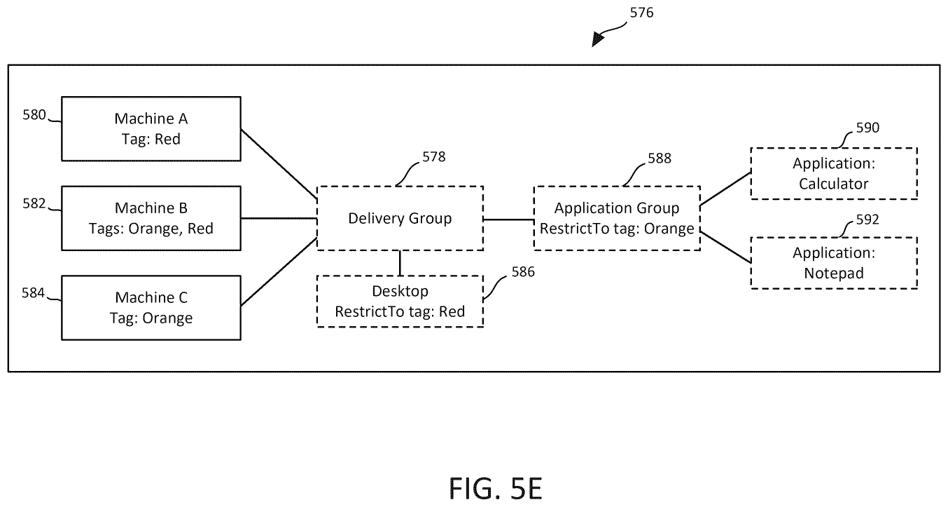

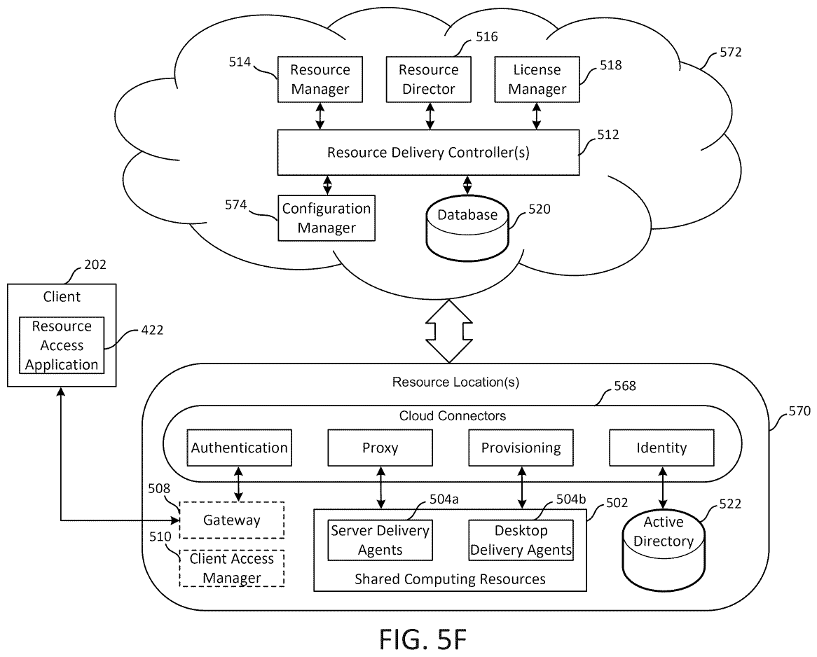

Computing systems and associated software often enable users to access different types of applications hosted in any of a number of different environments. A given client device 202 (examples of which are described below in Sections B and C) may, for example, be configured to access one or more local applications hosted on the client device 202 itself, one or more applications and/or desktops that are delivered to the client device 202 from a remote computing system, and/or one or more Software-as-a-Service (SaaS) applications, e.g., via a browser of the client device 202. The multi-resource access system 400 described in Section D below is an example of a system that may enable a client device 202 to seamlessly access (e.g., via a resource access application 422) one or more, or perhaps all, of such types of applications. Section E below describes an example system configuration in which one or more applications and/or desktops may be delivered from a remote computing system, e.g., via a resource delivery agent 504 of a shared computing resource 502, to a client device 202, e.g., via a resource access application 422 of the client device 202 (see FIG. 5C).

While accessing various applications, users often find it useful to copy data from an application to a clipboard and then paste the copied data from the clipboard to either the same application or a different application. As used herein, the terms “copy,” “copies,” “copied,” etc., refer to any operation in which a copy of a data item is made, whether or not the original version of the copied item remains at the location from which it was copied. Accordingly, an item that is “cut” from an application, e.g., by using a “CTRL-X” command in Microsoft Windows, would be considered to have been copied to a clipboard even though such an operation serves to remove the item from the application. A Windows “CTRL-C” command is another example of a command that can cause an item to be copied from an application to a clipboard in some implementations.

When a user invokes such a copy command (e.g., CTRL-C or CTRL-X) after selecting a data item of an application, the selected data item is generally written to a clipboard of the operating system that is being used to execute the application. For a local application hosted on a client device 202 or a SaaS application being accessed via a browser on a client device 202, the selected data item would thus typically be written to the clipboard for the operating system executing on the client device 202. For a delivered application or desktop, the selected data item would instead typically be written to a clipboard for the operating system executing on the remote computing system (e.g., a shared computing resource 502 - described in Section E) from which the application or desktop is being delivered. Likewise, when a user invokes a paste command (e.g., CTRL-V) while an operating system has given focus to a component of a particular application, whatever data happens to be on the operating system's clipboard at that time is typically written from the operating system clipboard to the application component which has the focus.

To account for scenarios in which a client device 202 is permitted to access one or more local resources, e.g., local applications or desktops, at the same time that one or more virtual resources are being delivered to the client device 202 (e.g., such that the client device 202 has a local application opened in a first window and a virtual application opened in a second window, or has a virtual desktop opened within a window of a local desktop), some systems employ “clipboard syncing” functionality to automatically synchronize the operating system clipboard of the client device 202 with the operating system clipboard of the remote computing resource (e.g., the shared computing resource 502 described in Section E). In such systems, users are thus permitted to copy data from a local application to a remote application (via the synchronized operating system clipboards), and vice versa. Example systems capable of employing clipboard synching functionality of this type are described, for example, in U.S. Pat. No. 11,057,464, the entire contents of which are incorporated herein by reference.

The inventors have recognized and appreciated that using the same operating system clipboard, or synchronized set of operating system clipboards, to service copy/paste operations for multiple applications can have undesirable consequences in at least some circumstances. For instance, a user may have selected and copied sensitive data (e.g., financial or personal data) from one application (e.g., NetSuite or Outlook) to the operating system clipboard(s) for a certain purpose, and at a later time may inadvertently copy that sensitive data from the operating system clipboard(s) to another application so that it becomes accessible to others, such as by inadvertently pasting the data within a Teams chat window.

To address this issue, the inventors have devised a system in which one or more applications accessible to a client device 202 may be associated with an isolated, private clipboard, or synchronized set of private clipboards, such that copy operations from such application(s) can be directed to such private clipboard(s), rather than to the operating system clipboard(s), and such that data may retrieved from such private clipboard(s), rather than the operating system clipboard(s), to satisfy paste operations requested by such application(s).

In some implementations, the private clipboard(s) may be divided into multiple isolated regions, with each such region serving as a private clipboard for a respective group of one or more applications. In such implementations, individual applications may be assigned a group identifier (ID) corresponding to a region of the private clipboard. Based on such group ID assignments, requests to copy selected data (e.g., via CNTL-X or CNTL-C commands) from any application in a particular group will result in the selected data being transferred from the requesting application to that group's private clipboard region, and requests to paste data (e.g., via CNTL-V commands) to any application in a particular group will result in data being transferred from that group's private clipboard region to the requesting application.

Further, in some implementations, respective private clipboards, or private clipboard regions, of the type described herein may be deployed for use by different operating systems (e.g., a local operating system of a client device 202 and a remote operating system of a shared computing resource 502), and such private clipboards, or private clipboard regions, may be synchronized so that a given application group may include applications executed on different operating systems. In such implementations, a user may be permitted to copy data from a local application in a group to a local private clipboard, or local private clipboard region, and may also be permitted to paste that copied data from a synchronized remote private clipboard, or remote private clipboard region, to a remote application in the same group. Similarly, in such implementations, a user may be permitted to copy data from a remote application in a group to a remote private clipboard, or remote private clipboard region, and may also be permitted to paste that copied data from a synchronized local private clipboard, or local private clipboard region, to a local application in the same group.

Still further, in some implementations, requests to copy data from or paste data to any applications not assigned to a group may be serviced in a conventional fashion using the operating system clipboard(s) associated with those applications.

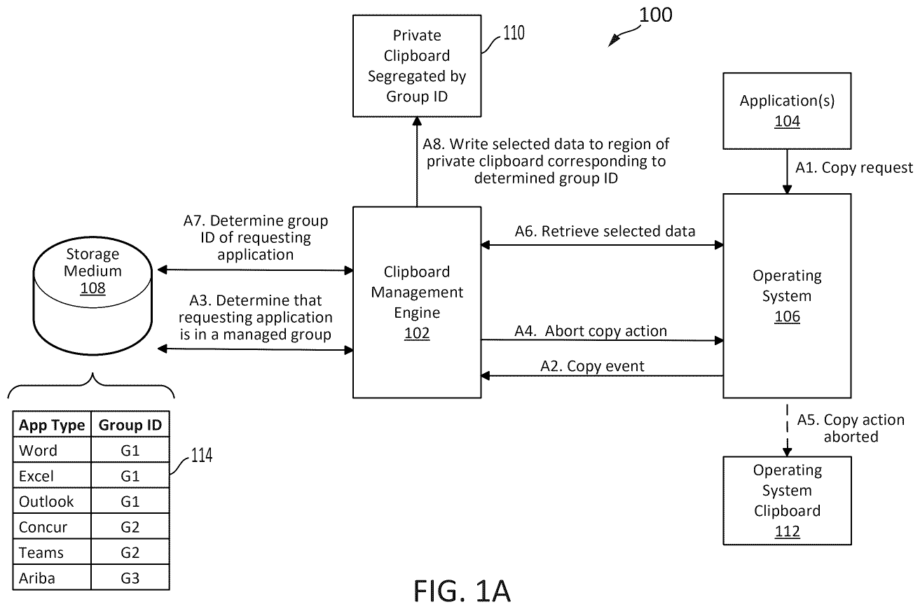

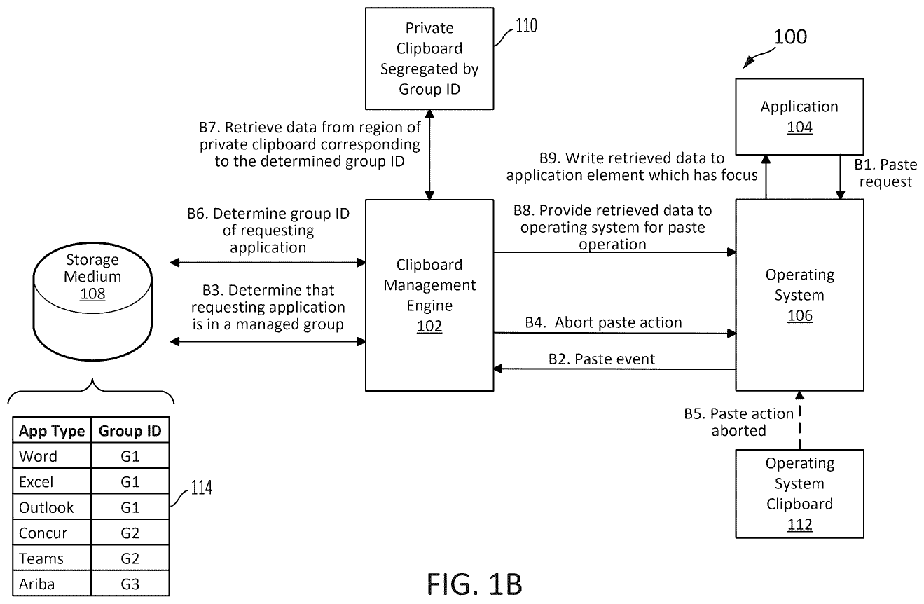

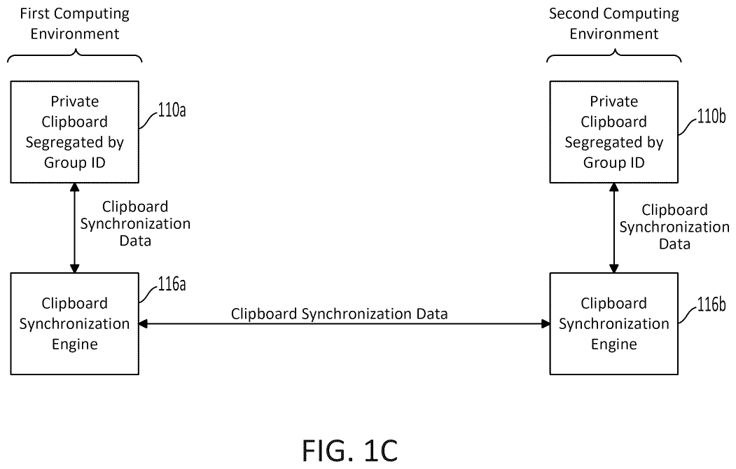

FIGS. 1A and 1B each show an example system 100 configured to provide isolated clipboard regions for particular applications and/or groups of applications in accordance with some aspects of the present disclosure. As shown, in some implementations, the system 100 may include a clipboard management engine 102 that interacts with an operating system 106 and a storage medium 108 to enable the use of a private clipboard 110, rather than an operating system clipboard 112, for receiving and storing selected data from one or more applications 104 in response to copy requests and for supplying stored data to the application(s) 104 in response to paste requests.

FIG. 1A illustrates a first process that may be employed by the system 100 when a copy request (e.g., via a CNTL-X or CNTL-C command) is received by the operating system 106 while a data item of an application 104 (e.g. a text block, an image, a document, etc.) is in a selected state. As described in more detail below, in some implementations, the first process (shown in FIG. 1A) may cause the selected data to be written to a particular isolated region of the private clipboard 110 that corresponds to the application 104, rather than to the operating system clipboard 112. FIG. 1B illustrates a second process that may be employed by the system 100 when a paste request (e.g., via a CNTL-V command) is received by the operating system 106 while focus has been given to a component of an application 104, which may or may not be the same application 104 that supplied the data item to the private clipboard 110. As also described in more detail below, in some implementations, the second process (shown in FIG. 1B) may cause a data item stored in a particular isolated region of the private clipboard 110 that corresponds to the application 104 to be transferred to the component of the application 104 to which focus has been given.

In some implementations, all, or nearly all, of the components of the system 100 shown in FIGS. 1A and 1B may be implemented within the same computing system 300 (an example of which is described in Section C), such as by one or more processors 302 and one or more computer-readable media 304, 306 of a client device 202, or, alternatively, by one or more processors 302 and one or more computer-readable media 304, 306 of a remote computing system that delivers one or more applications and/or desktops to a client device 202, such as one of the shared computing resources 502 described in Section E. The application(s) 104 shown in FIGS. 1A and 1B may be of any of numerous types and may be made accessible to a client device 202 in any of a number of ways. In some implementations, for example, the applications 104 may be accessed via a resource access application 422 associated with a client device 202, as described in Sections D and E. In some implementations, one or more of the applications 104 may be SaaS applications that are accessed via a browser of the client device 202. For instance, in some implementations, a specialized browser embedded within a resource access application 422 may be used to access one or more such SaaS applications, as described in Section D. In some implementations, one or more of the applications 104 may additionally or alternatively be applications that are executed locally on a client device 202. Further, as noted previously, in some implementations, the system 100 may correspond to a remote computing system, e.g., a shared computing resource 502, and one or more of the applications 104 may be applications and/or desktops that are delivered from the remote computing system to a client device 202, as described in Section E.

The clipboard management engine 102 of the system 100 (shown in FIGS. 1A and 1B) may likewise take on any of numerous forms. In some implementations, for example, the clipboard management engine 102 may be a component of the resource access application 422 of a client device 202 in a multi-resource access system 400 (described in Section D). Such an implementation may, for example, enable the transferring of data items between local applications and/or browser-accessed SaaS applications and a local private clipboard 110. In other implementations, the clipboard management engine 102 may be a component of a resource delivery agent 504 of a shared computing resource 502 in a resource delivery system 500 (described in Section E). Such an implementation may, for example, enable the transferring of data items between remote applications and/or desktops and a remote private clipboard 110. In other implementations, the clipboard management engine 102 may be independent of a resource access application 422 and/or a resource delivery agent 504. For instance, in some implementations, the clipboard management engine 102 may be a standalone application executing on a client device 202 or a remote computing system, or may be a plug-in or add-in to another application such as a browser that is used to access SaaS applications.

The private clipboard 110 may also be implemented in any of a number of ways. In some implementations, for example, a particular region of random access memory (RAM) of the host device (e.g., a client device 202 or a shared computing resource 502) may be isolated and dedicated for use as a private clipboard 110 by the clipboard management engine 102. In some implementations, such isolated memory region may further be segregated into separate, isolated sub-regions corresponding to respective application group IDs. In such implementations, assigning a particular group ID to a given application 104 (e.g., per a table 114—described in more detail below) may cause the system 100, in response to a copy request made while a data item is selected by that application 104, to transfer the data item from the application 104 to the sub-region of the private clipboard 110 that has the same group identifier as the application 104, and may additionally cause the system 100, in response to receipt of a paste request while focus has been given to that application 104, to transfer a data item from that particular sub-region to the application 104.

As shown in FIGS. 1A and 1B, the storage medium 108 may store data, e.g., as a table 114 or otherwise, that associates particular types of applications 104 with group IDs. In the illustrated example, three application types (“Word,” “Excel,” and “Outlook”) have been assigned a first group ID (i.e., “G1”), two application types (“Concur” and “Teams” have been assigned a second group ID (i.e., “G2”), and one application type (“Ariba”) has been assigned a third group ID (i.e., “G3”).

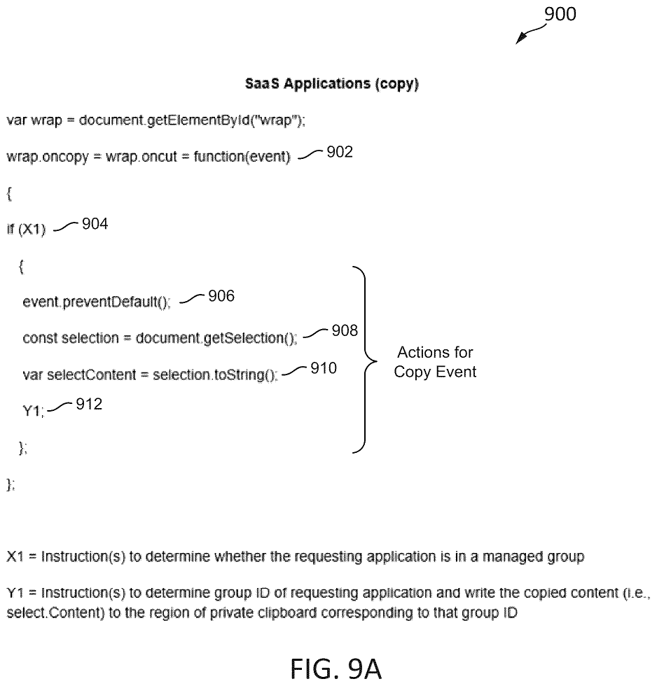

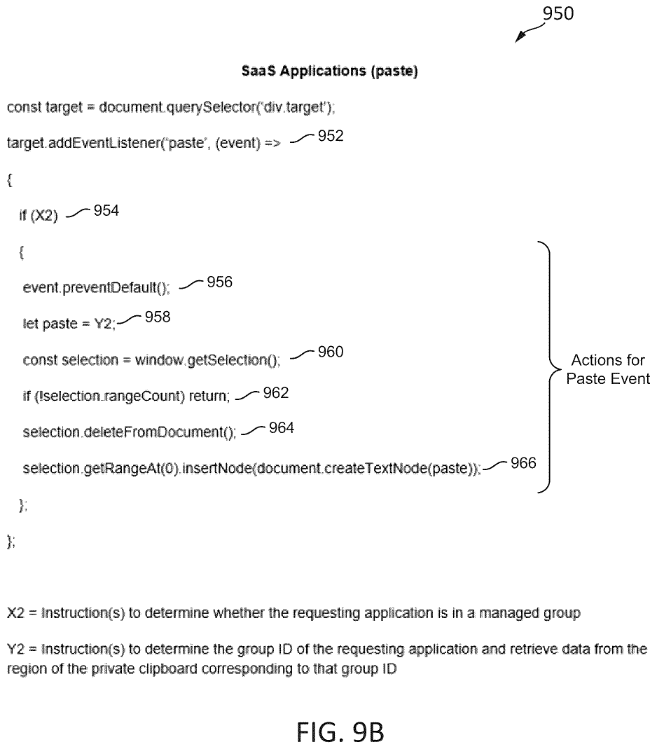

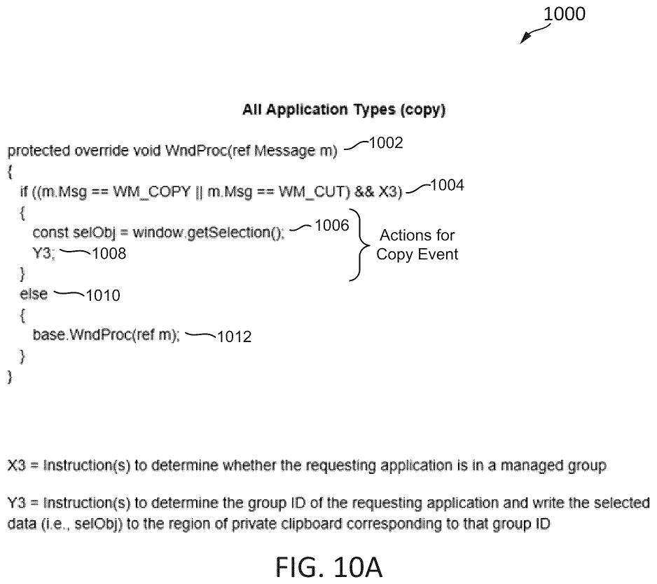

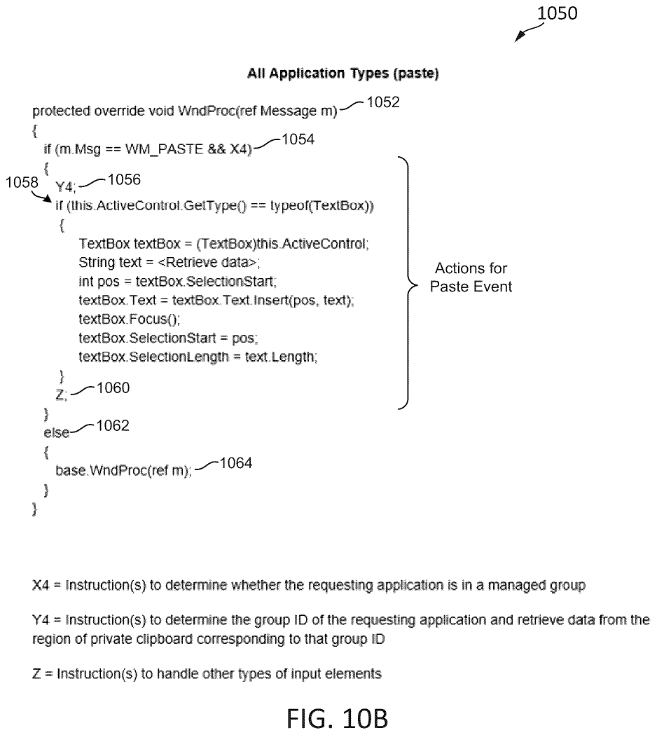

The process of FIG. 1A will now be described. Examples of code modules that may be executed by the clipboard management engine 102 to perform the process of FIG. 1A are described in Section G below in connection with FIGS. 9A and 10A, with the code module 900 of FIG. 9A being usable where the application(s) 104 are SaaS applications, and the code module 1000 of FIG. 10A being usable with any type of applications(s) 104.

As shown in FIG. 1A, at a step A1, the operating system 106 may receive a copy request while a data item of an application 104 has been selected. For example, a user may have operated a browser on the client device 202 to highlight block of text presented by a SaaS application, e.g., Outlook 365, and then entered a copy command, e.g., by pressing CNTL-C on a keyboard.

At a step A2, the operating system 106 may notify the clipboard management engine 102 that a copy operation has been requested. In some implementations, for example, the clipboard management engine 102 may use one or more APIs of the operating system 106 to hook into clipboard copy events and to take certain actions when such copy events occur. Examples of instructions that may be executed by the clipboard management engine 102 to enable the clipboard management engine 102 to determine that such a copy operation has been requested are described below in connection with FIGS. 9A and 10A.

At a step A3, the clipboard management engine 102 may determine that the application 104 that requested the copy operation (e.g., Outlook 365) is included in an application group that is managed by the system 100. To make such a determination, the clipboard management engine 102 may, for example, determine whether the application 104 that requested the copy operation (e.g., Outlook 365) is listed in the table 114 and/or has been assigned a group ID corresponding to a managed application group.

At a step A4, upon determining that the requesting application 104 is included in an application group that is managed by the system 100, the clipboard management engine 102 may instruct the operating system 106 to abort the requested copy operation, thus stopping the selected data from being written to the operating system clipboard 112. In some implementations, such an instruction may also be made via one or more APIs of the operating system 106. Examples of instructions that may be executed by the clipboard management engine 102 to enable the clipboard management engine 102 to instruct the operating system 106 to abort the requested copy operation are described below in connection with FIGS. 9A and 10A. As indicated by a step A5, execution of such instruction(s) may cause the operating system 106 to refrain from copying the selected data to the operating system clipboard 112.

At a step A6, the clipboard management engine 102 may retrieve the selected data item from the operating system 106. In some implementations, the clipboard management engine 102 may again use one or more APIs of the operating system 106 for this purpose. Examples of instructions that may be executed by the clipboard management engine 102 to obtain from the operating system 106 the data that has been selected within the application 104 are described below in connection with FIGS. 9A and 10A.

At a step A7, the clipboard management engine 102 may access the table 114 in the storage medium 108 to determine the group ID that is associated with the application 104 from which the copy request originated. For example, if the copy request was made when a data item in an Outlook application was selected, the clipboard management engine 102 may determine, based on the entries in the table 114, that the Outlook application is associated with the group G1.

Finally, at a step A8, the clipboard management engine 102 may write the selected data that was received from the operating system 106 to a region of the private clipboard 110 corresponding to the group ID identified at the step A7.

The process of FIG. 1B will now be described. Examples of code modules that may be executed by the clipboard management engine 102 to perform the process of FIG. 1B are described in Section G below in connection with FIGS. 9B and 10B, with the code module 950 of FIG. 9B being usable where the application(s) 104 are SaaS applications, and the code module 1050 of FIG. 10B being usable with any type of applications(s) 104.

As shown in FIG. 1B, at a step B1, the operating system 106 may receive a paste request while an element of the application 104 has been given focus. For example, a user may have operated a browser on the client device 202 to move a cursor to a location within a SaaS application, e.g., a chat box of a Teams application, and then entered a paste command, e.g., by pressing CNTL-V on a keyboard.

At a step B2, the operating system 106 may notify the clipboard management engine 102 that a paste operations has been requested. In some implementations, for example, the clipboard management engine 102 may use one or more APIs of the operating system 106 to hook into clipboard paste events and to take certain actions when such paste events occur. Examples of instructions that may be executed by the clipboard management engine 102 to enable the clipboard management engine 102 to determine that such a paste operation has been requested are described below in connection with FIGS. 9B and 10B.

At a step B3, the clipboard management engine 102 may determine that the application 104 that requested the paste operation (e.g., Teams) is included in an application group that is managed by the system 100. To make such a determination, the clipboard management engine 102 may, for example, determine whether the application that requested the paste operation (e.g., Teams) is listed in the table 114 and/or has been assigned a group ID corresponding to a managed application group.

At a step B4, upon determining that the requesting application 104 is included in an application group that is managed by the system 100, the clipboard management engine 102 may instruct the operating system 106 to abort the requested paste operation, thus stopping the selected data from being retrieved from the operating system clipboard 112. In some implementations, such an instruction may also be made via one or more APIs of the operating system 106. Examples of instructions that may be executed by the clipboard management engine 102 to enable the clipboard management engine 102 to instruct the operating system 106 to abort the requested paste operation are described below in connection with FIGS. 9B and 10B. As indicated by a step B5, execution of such instruction(s) may cause the operating system 106 to refrain from retrieving data from the operating system clipboard 112.

At a step B6, the clipboard management engine 102 may access the table 114 in the storage medium 108 to determine the group ID that is associated with the application 104 from which the paste request originated. For example, if the paste request was made when an element of a Teams application had been given focus, the clipboard management engine 102 may determine, based on the entries in the table 114, that the Teams application is associated with the group G2.

At a step B7, the clipboard management engine 102 may retrieve data from the region of the private clipboard 110 corresponding to the group ID determined at the step B6.

At a step B8, the clipboard management engine 102 may provide the retrieved data to the operating system 106, and may instruct the operating system 106 to write that data to the element of the application 104 which has been given focus. In some implementations, the clipboard management engine 102 may again use one or more APIs of the operating system 106 for this purpose. Examples of instructions that may be executed by the clipboard management engine 102 to write that data to the element of the application 104 which has been given focus are described below in connection with FIGS. 9B and 10B.

Finally, at a step B9, the operating system 106 may, further to the instruction(s) provided at the step B8, write the retrieved data to the element of the application 104 which has been given focus.

It can be noted that if the example “paste” process of FIG. 1B was performed to paste data to a Teams application (which is in the group G2) immediately after the “copy” process of FIG. 1A was used to copy data from an Outlook application (which is in the group G1), the data copied to the Teams application would not be the data that was copied from the Outlook application. In such a scenario, the data copied to the Teams application would instead be whatever data was stored in the isolated region of the private clipboard 110 corresponding to the group G2. If, on the other hand, the example “paste” process of FIG. 1B was performed to paste data to a Word application (which is in the group G1) immediately after the “copy” process of FIG. 1A was used to copy data from an Outlook application (which is also in the group G1), the data copied to the Word application would be the data that was copied from the Outlook application, because both of those applications are in the same group (i.e., the group G1).

FIG. 1C shows how, in some implementations, one private clipboard 110a in a first computing environment (e.g., on a client device 202) may be synchronized with another private clipboard 110b in a second computing environment (e.g., on a shared computing resource 502) so as to enable data to be copied from one application to the private clipboard 110a in the first computing environment and pasted from the second private clipboard 110b to another application in the second computing environment, or vice versa, as described above.

As illustrated in FIG. 1C, in some implementations, respective clipboard synchronization engines 116a, 116b may be deployed in the different computing environments to keep the two private clipboards 110a, 110b in sync. The clipboard synchronization engines 116a and 116b may, for example, be components of a resource access application 422 within the first computing environment and the resource delivery agent 504 within the second computing environment, respectively. In some implementations, the clipboard synchronization engines 116a, 116b may be configured such that changes reflected in either of the private clipboards 110a, 110b will be propagated to the other private clipboard 110b, 110a. Further, in some implementations, techniques may be employed to minimize the unnecessary transfer of data between the different computing environments. For instance, in some embodiments, a data transfer between the private clipboards 110a, 110b may be performed immediately in response to a small quantity of data being written to one of the private clipboards 110, whereas, for larger quantities of data, a data transfer may be performed between the private clipboards 110a, 110b only in response to receipt of a paste command. One or more of the inter-clipboard data transfer management techniques described in U.S. Pat. No. 11,057,464, incorporated by reference above, may additionally or alternatively be employed with respect to the private clipboards 110a, 110b in some embodiments.

Additional details and example implementations of embodiments of the present disclosure are set forth below in Sections G and H, following a description of example systems and network environments in which such embodiments may be deployed.

### B. Network Environment

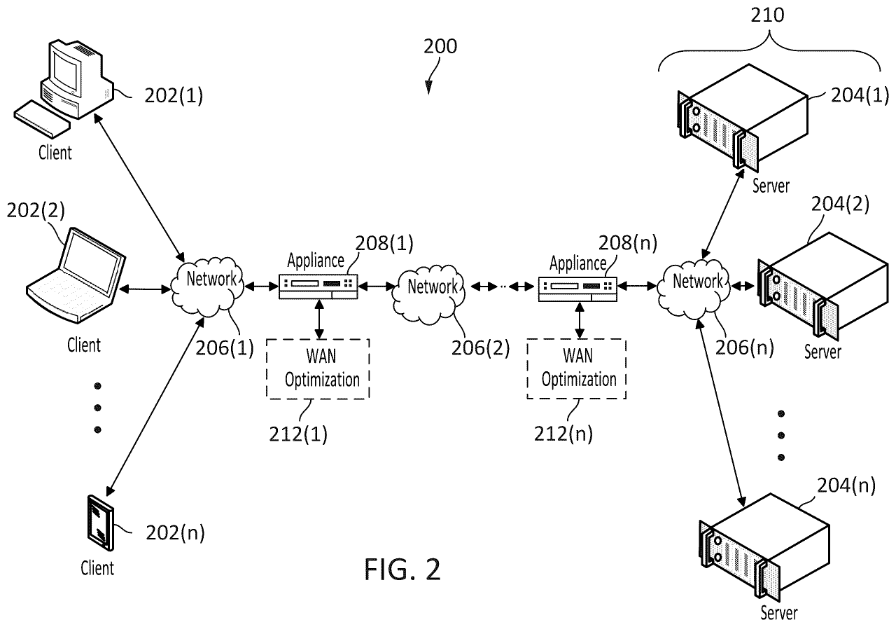

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, FL, such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, FL, such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+an organization.

### C. Computing Environment

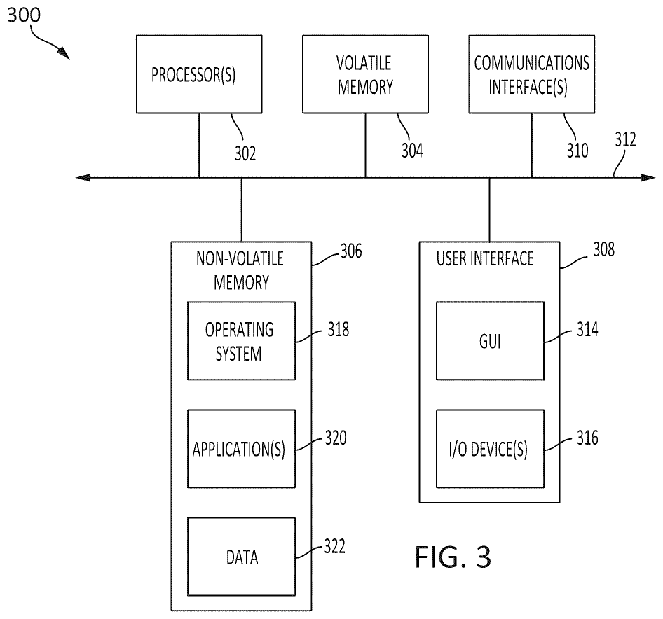

FIG. 3 illustrates an example of a computing system 300 that may be used to implement one or more of the respective components (e.g., the clients 202, the servers 204, and the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Managing and Streamlining Access by Client Devices to a Variety of Resources

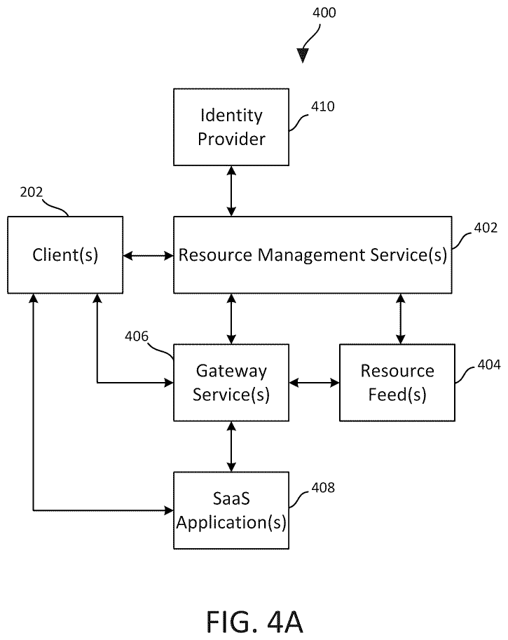

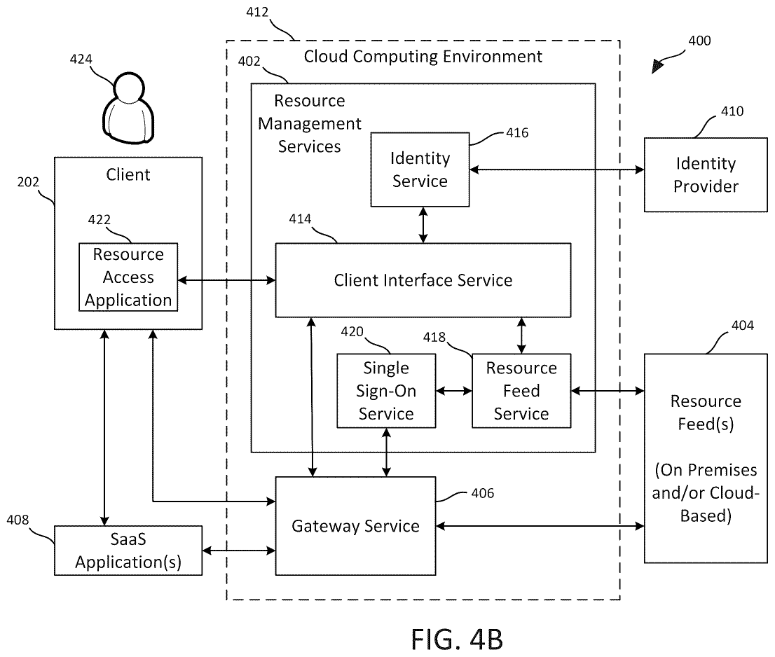

FIG. 4A is a block diagram of an example multi-resource access system 400 in which one or more resource management services 402 may manage and streamline access by one or more clients 202 to one or more resource feeds 404 (via one or more gateway services 406) and/or one or more software-as-a-service (SaaS) applications 408. In particular, the resource management service(s) 402 may employ an identity provider 410 to authenticate the identity of a user of a client 202 and, following authentication, identify one or more resources the user is authorized to access. In response to the user selecting one of the identified resources, the resource management service(s) 402 may send appropriate access credentials to the requesting client 202, and the client 202 may then use those credentials to access the selected resource. For the resource feed(s) 404, the client 202 may use the supplied credentials to access the selected resource via a gateway service 406. For the SaaS application(s) 408, the client 202 may use the credentials to access the selected application directly.

The client(s) 202 may be any type of computing devices capable of accessing the resource feed(s) 404 and/or the SaaS application(s) 408, and may, for example, include a variety of desktop or laptop computers, smartphones, tablets, etc. The resource feed(s) 404 may include any of numerous resource types and may be provided from any of numerous locations. In some embodiments, for example, the resource feed(s) 404 may include one or more systems or services for providing virtual applications and/or desktops to the client(s) 202, one or more file repositories and/or file sharing systems, one or more secure browser services, one or more access control services for the SaaS applications 408, one or more management services for local applications on the client(s) 202, one or more internet enabled devices or sensors, etc. The resource management service(s) 402, the resource feed(s) 404, the gateway service(s) 406, the SaaS application(s) 408, and the identity provider 410 may be located within an on-premises data center of an organization for which the multi-resource access system 400 is deployed, within one or more cloud computing environments, or elsewhere.

FIG. 4B is a block diagram showing an example implementation of the multi-resource access system 400 shown in FIG. 4A in which various resource management services 402 as well as a gateway service 406 are located within a cloud computing environment 412. The cloud computing environment may, for example, include Microsoft Azure Cloud, Amazon Web Services, Google Cloud, or IBM Cloud. It should be appreciated, however, that in other implementations, one or more (or all) of the components of the resource management services 402 and/or the gateway service 406 may alternatively be located outside the cloud computing environment 412, such as within a data center hosted by an organization.

For any of the illustrated components (other than the client 202) that are not based within the cloud computing environment 412, cloud connectors (not shown in FIG. 4B) may be used to interface those components with the cloud computing environment 412. Such cloud connectors may, for example, run on Windows Server instances and/or Linux Server instances hosted in resource locations and may create a reverse proxy to route traffic between those resource locations and the cloud computing environment 412. In the illustrated example, the cloud-based resource management services 402 include a client interface service 414, an identity service 416, a resource feed service 418, and a single sign-on service 420. As shown, in some embodiments, the client 202 may use a resource access application 422 to communicate with the client interface service 414 as well as to present a user interface on the client 202 that a user 424 can operate to access the resource feed(s) 404 and/or the SaaS application(s) 408. The resource access application 422 may either be installed on the client 202, or may be executed by the client interface service 414 (or elsewhere in the multi-resource access system 400) and accessed using a web browser (not shown in FIG. 4B) on the client 202.

As explained in more detail below, in some embodiments, the resource access application 422 and associated components may provide the user 424 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 422 is launched or otherwise accessed by the user 424, the client interface service 414 may send a sign-on request to the identity service 416. In some embodiments, the identity provider 410 may be located on the premises of the organization for which the multi-resource access system 400 is deployed. The identity provider 410 may, for example, correspond to an on-premises Windows Active Directory. In such embodiments, the identity provider 410 may be connected to the cloud-based identity service 416 using a cloud connector (not shown in FIG. 4B), as described above. Upon receiving a sign-on request, the identity service 416 may cause the resource access application 422 (via the client interface service 414) to prompt the user 424 for the user's authentication credentials (e.g., username and password). Upon receiving the user's authentication credentials, the client interface service 414 may pass the credentials along to the identity service 416, and the identity service 416 may, in turn, forward them to the identity provider 410 for authentication, for example, by comparing them against an Active Directory domain. Once the identity service 416 receives confirmation from the identity provider 410 that the user's identity has been properly authenticated, the client interface service 414 may send a request to the resource feed service 418 for a list of subscribed resources for the user 424.

In other embodiments (not illustrated in FIG. 4B), the identity provider 410 may be a cloud-based identity service, such as a Microsoft Azure Active Directory. In such embodiments, upon receiving a sign-on request from the client interface service 414, the identity service 416 may, via the client interface service 414, cause the client 202 to be redirected to the cloud-based identity service to complete an authentication process. The cloud-based identity service may then cause the client 202 to prompt the user 424 to enter the user's authentication credentials. Upon determining the user's identity has been properly authenticated, the cloud-based identity service may send a message to the resource access application 422 indicating the authentication attempt was successful, and the resource access application 422 may then inform the client interface service 414 of the successfully authentication. Once the identity service 416 receives confirmation from the client interface service 414 that the user's identity has been properly authenticated, the client interface service 414 may send a request to the resource feed service 418 for a list of subscribed resources for the user 424.

The resource feed service 418 may request identity tokens for configured resources from the single sign-on service 420. The resource feed service 418 may then pass the feed-specific identity tokens it receives to the points of authentication for the respective resource feeds 404. The resource feeds 404 may then respond with lists of resources configured for the respective identities. The resource feed service 418 may then aggregate all items from the different feeds and forward them to the client interface service 414, which may cause the resource access application 422 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 408 to which the user 424 has subscribed. The lists of local applications and the SaaS applications 408 may, for example, be supplied by resource feeds 404 for respective services that manage which such applications are to be made available to the user 424 via the resource access application 422. Examples of SaaS applications 408 that may be managed and accessed as described herein include Microsoft Office 365 applications, SAP SaaS applications, Workday applications, etc.

For resources other than local applications and the SaaS application(s) 408, upon the user 424 selecting one of the listed available resources, the resource access application 422 may cause the client interface service 414 to forward a request for the specified resource to the resource feed service 418. In response to receiving such a request, the resource feed service 418 may request an identity token for the corresponding feed from the single sign-on service 420. The resource feed service 418 may then pass the identity token received from the single sign-on service 420 to the client interface service 414 where a launch ticket for the resource may be generated and sent to the resource access application 422. Upon receiving the launch ticket, the resource access application 422 may initiate a secure session to the gateway service 406 and present the launch ticket. When the gateway service 406 is presented with the launch ticket, it may initiate a secure session to the appropriate resource feed and present the identity token to that feed to seamlessly authenticate the user 424. Once the session initializes, the client 202 may proceed to access the selected resource.

When the user 424 selects a local application, the resource access application 422 may cause the selected local application to launch on the client 202. When the user 424 selects a SaaS application 408, the resource access application 422 may cause the client interface service 414 to request a one-time uniform resource locator (URL) from the gateway service 406 as well a preferred browser for use in accessing the SaaS application 408. After the gateway service 406 returns the one-time URL and identifies the preferred browser, the client interface service 414 may pass that information along to the resource access application 422. The client 202 may then launch the identified browser and initiate a connection to the gateway service 406. The gateway service 406 may then request an assertion from the single sign-on service 420. Upon receiving the assertion, the gateway service 406 may cause the identified browser on the client 202 to be redirected to the logon page for identified SaaS application 408 and present the assertion. The SaaS may then contact the gateway service 406 to validate the assertion and authenticate the user 424. Once the user has been authenticated, communication may occur directly between the identified browser and the selected SaaS application 408, thus allowing the user 424 to use the client 202 to access the selected SaaS application 408.

In some embodiments, the preferred browser identified by the gateway service 406 may be a specialized browser embedded in the resource access application 422 (when the resource access application 422 is installed on the client 202) or provided by one of the resource feeds 404 (when the resource access application 422 is located remotely), e.g., via a secure browser service. In such embodiments, the SaaS applications 408 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 404) for assessment of its security risk by a web filtering service. For approved URLs, the specialized browser may be permitted to access the link. For suspicious links, however, the web filtering service may have the client interface service 414 send the link to a secure browser service, which may start a new virtual browser session with the client 202, and thus allow the user to access the potentially harmful linked content in a safe environment.

### E. Systems and Methods for Delivering Virtualized Applications and/or Desktops to Client Devices

FIG. 5A is a block diagram illustrating key components of a resource delivery system 500 that may enable a client device 202 to remotely access one or more virtual applications or desktops running on one or more shared computing resources 502. The shared computing resources 502 may include physical machines and/or virtual (e.g., hypervisor driven) machines, and may be located at a data center, within a cloud computing environment, or elsewhere. As described in more detail below, such shared computing resources 502 may implement one or more resource delivery agents 504, including one or more server delivery agents 504a and/or one or more desktop delivery agents 504b. The Virtual Delivery Agents (VDAs) of the Citrix Virtual Apps and Desktops™ system offered by Citrix Systems, Inc., of Fort Lauderdale, Florida, are example implementations of the resource delivery agents 504. In some implementations, the resource delivery system 500 may give an information technology (IT) department of an organization control of virtual machines, applications, licensing, and security while providing “anywhere access” for any device. As described below, the resource delivery system 500 may enable end users to run applications and/or desktops independently of the operating system and interface of the end user's device. Further, the resource delivery system 500 may enable administrators to manage the network and control access from selected devices or from all devices, as well as to manage an entire network from a single data center.

The resource delivery system 500 shown in FIG. 5A may, for example, correspond to an implementation of a Citrix Virtual Apps and Desktops™ system offered by Citrix Systems, Inc., of Fort Lauderdale, Florida. Such systems employ a unified architecture called FlexCast Management Architecture (FMA). Among other things, FMA provides the ability to run multiple versions of Citrix Virtual Apps or Citrix Virtual Desktops™ as well as integrated provisioning.

As shown in FIG. 5A, in addition to the shared computing resources 502, the resource delivery system 500 may include a gateway 508, a client access manager 510, one or more resource delivery controllers 512, a resource manager 514, a resource director 516, a license manager 518, one or more databases 520, and an Active Directory (AD) 522 or other directory service.

The resource delivery controller(s) 512 may be the central management component of the resource delivery system 500. In some implementations, the resource delivery controller(s) 512 may be installed on at least one server in a data center of an organization. The Delivery Controller of the Citrix Virtual Apps and Desktops™ system offered by Citrix Systems, Inc., of Fort Lauderdale, Florida, is one example implementation of the resource delivery controller(s) 512. For reliability and availability, respective resource delivery controllers 512 may be installed on multiple servers. The resource delivery controller(s) 512 may communicate with the shared computing resources 502 to distribute applications and/or desktops, authenticate and manage user access, broker connections between client devices 202 and resource delivery agents 504 running on respective shared computing resources 502, optimize use connections, and/or load-balance use connections. As described in more detail below, a broker service 532 (shown in FIGS. 5B-5D) of the resource delivery controller(s) 512 may interact with the database(s) 520 to track which users are logged on and where, what session resources the users have, and if users need to reconnect to existing applications. In some implementations, the broker service 532 may execute PowerShell commands and communicate with broker agents 556 (shown in FIG. 5D) of the resource delivery agents 504 over transmission control protocol (TCP) port “80.” A monitor service 560 (shown in FIG. 5D) may also be provided by the resource delivery controller(s) 512 to collect historical data concerning the operation of the resource delivery controller(s) 512 and write such data to the database(s) 520. In some implementations, such a monitor service 560 may use TCP port “80” or “443.”

The resource delivery controller(s) 512 may manage the state of desktops, starting and stopping them based on demand and administrative configuration. In some implementations, the resource delivery controller(s) 512 may also enable the adjustment of user profiles (stored within the database(s) 520) to manage user personalization settings in virtualized or physical Windows environments.

In some implementations, the database(s) 520 may include at least one Microsoft Structured Query Language (SQL) Server database in which configuration and session information may be stored. As noted above, the database(s) 520 may store the data collected and managed by the services that make up the resource delivery controller(s) 512. In some implementations, the database(s) 520 may be provided within a data center of an organization and may have a persistent connection to the resource delivery controller(s) 512. Although not illustrated in FIG. 5A, it should be appreciated that the resource delivery system 500 may also include respective databases associated with the resource manager 514, the resource director 516, and the license manager 518 to store data collected and/or used by those components.

The resource delivery agents 504 may be installed on physical or virtual machines that are made available to deliver applications or desktops to users. The resource delivery agents 504 may enable such machines to register with the resource delivery controller(s) 512. The registration of a machine with the resource delivery controller(s) 512 may cause that machine and the resources it is hosting to be made available to users. The resource delivery agents 504 may establish and manage the connections between the machines on which they are installed and client devices 202. The resource delivery agents 504 may also verify that a license is available for the user and/or session, and may apply policies that are configured for the session.

The resource delivery agents 504 may communicate session information to the broker service 532 (shown in FIGS. 5B-5D) of the resource delivery controller(s) 512 through the broker agents 556 (shown in FIG. 5D) in the resource delivery agents 504. Such broker agents 556 may host multiple plugins and collect real-time data. In some implementations, the broker agents 556 may communicate with the resource delivery controller(s) 512 over TCP port “80.” In some implementations, the resource delivery agents 504 may operate with Single-session and/or Multi-session Windows operating systems. The resource delivery agents 504 for Multi-session Windows operating systems may allow multiple users to connect to the server at one time. The resource delivery agents 504 for Single-session Windows operating systems, on the other hand, may allow only one user to connect to the desktop at a time. In some implementations, one or more the resource delivery agents 504 may alternatively operate with a Linux operating system.

When users connect from outside one or more corporate firewalls, e.g., firewalls 526a and 526b shown in FIG. 5A, the gateway 508 may be used to secure such connections with Transport Layer Security (TLS). The gateway 508 may, for example, be a Secure Socket Layer (SLL) Virtual Private Network (VPN) appliance that is deployed in a demilitarized zone (DMZ) 528. The gateway 508 may thus provide a single secure point of access through the corporate firewall 526.

The client access manager 510 of the resource delivery system 500 may authenticate users and manage stores of desktops and/or applications that are available for users to access. In some implementations, the client access manager 510 may provide an application “storefront” for an enterprise, which may provide users with self-service access to the desktops and/or applications that the enterprise opts to make available to them. In some implementations, the client access manager 510 may also keep track of users' application subscriptions, shortcut names, and other data. Tracking such data may, for example, help ensure that users have a consistent experience across multiple devices.

As shown in FIG. 5A, a resource access application 422 may be installed on client devices 202 or other endpoints (such as virtual desktops). Such resource access applications 422 may provide users with quick, secure, self-service access to documents, applications, and/or desktops. The resource access application 422 may, for example, provide on-demand access to Windows, web, and/or Software as a Service (SaaS) applications. The Citrix Workspace™ app, offered by Citrix Systems, Inc., of Fort Lauderdale, Florida, is one example implementation of such a client-based version of the resource access application 422. In some implementations, the resource access application 422 may alternatively operate on a web server (not shown in FIG. 5A) and may be accessed using a web browser (also not shown in FIG. 5A) installed on the client device 202. In some embodiments, f422or example, the resource access application 422 may be provided as a hypertext markup language 5 (HTML5) service and may be accessed using an HTML5-compatible web browser. The Citrix Workspace™ app for HTML5, offered by Citrix Systems, Inc., of Fort Lauderdale, Florida, is one example implementation of such a web-based version of the resource access application 422.

In some embodiments, the resource access application 422 may intercept network communications from a network stack used by the one or more applications. For example, the resource access application 422 may intercept a network communication at any point in a network stack and redirect the network communication to a destination desired, managed, and/or controlled by the resource access application 422, for example, to intercept and redirect a transport layer connection to an IP address and port controlled and/or managed by resource access application 422. The resource access application 422 may thus, in some embodiments, transparently intercept any protocol layer below the transport layer, such as the network layer, and any protocol layer above the transport layer, such as the session, presentation, or application layers. The resource access application 422 may, for example, interface with the transport layer to secure, optimize, accelerate, route, and/or load-balance any communications provided via any protocol carried by the transport layer.

In some embodiments, the resource access application 422 may be implemented as an Independent Computing Architecture (ICA) client developed by Citrix Systems, Inc. The resource access application 422 may perform acceleration, streaming, monitoring, and/or other operations. For example, the resource access application 422 may accelerate streaming an application from a shared computing resource 502 running a resource delivery agent 504 to the client device 202. The resource access application 422 may also perform endpoint detection/scanning and/or collect endpoint information about the client 202. For example, the resource access application 422 may identify and determine one or more client-side attributes, such as: the operating system and/or a version of an operating system, a service pack of the operating system, a running service, a running process, a file, presence or versions of various applications of the client, such as antivirus, firewall, security, and/or other software.

The resource manager 514 shown in FIG. 5A, may provide a console from which the configuration and management of applications and desktops that are to be made available to users may be controlled. The Studio component of the Citrix Virtual Apps and Desktops™ system offered by Citrix Systems, Inc., of Fort Lauderdale, Florida, is one example implementation of the resource manager 514. In some implementations, the resource manager 514 may eliminate the need for separate management consoles for managing delivery of applications and desktops. In some embodiments, the resource manager 514 may provide one or more wizards to guide system administrators through environment setup, creating workloads to host applications and desktops, and assigning applications and desktops to users. In some implementations, the resource manager 514 may also be used to allocate and track licenses for the resource delivery system 500. In some embodiments, the resource manager 514 may get the information it displays from the broker service 532 of the resource delivery controller(s) 512, e.g., communicating over TCP port “80.”

The resource director 516 may, for example, be a web-based tool that enables IT support and help desk teams to monitor an environment, troubleshoot issues before they become system-critical, and perform support tasks for end users. The Director component of the Citrix Virtual Apps and Desktops™ system offered by Citrix Systems, Inc., of Fort Lauderdale, Florida, is one example implementation of the resource director 516. In some implementations, a single deployment of the resource director 516 may be used to connect to and monitor multiple resource delivery systems 500, such as that shown in FIG. 5A. Examples of information that may be displayed by the resource director 516 include (A) real-time session data from the broker service 532 of the resource delivery controller(s) 512, which may include data the broker service 532 gets from the broker agent 556 in the resource delivery agents 504, and (B) historical data about the resource delivery system 522 that may be received, for example, from the monitor service 560 in the resource delivery controller(s) 512. In some implementations, the resource director 516 may use performance and heuristics data captured by the gateway 508 (described below) to build analytics from the data and then presents such analytics to system administrators. Further, in some implementations, the resource director 516 may allow system administrators to view and interact with a user's sessions, e.g., using Windows Remote Assistance.

The license manager 518, as its name implies, may enable the management of licenses within the resource delivery system 500. In some implementations, the license manager 518 may communicate with the resource delivery controller(s) 512 to manage licensing for a user's session and with the resource manager 514 to allocate license files.

As noted above, in some implementations, the shared computing resources 502 shown in FIG. 5A may include one or more virtual machines. These can be virtual machines that are used to host applications and/or desktops, as well as virtual machines that are used to host the other components of the resource delivery system 500. In some implementations, a hypervisor may be installed on a host computer to run the hypervisor and hosting virtual machines.

Although not depicted in FIG. 5A, in some implementations, the resource delivery system 500 may additionally include a performance monitoring service or agent. In some embodiments, one or more dedicated servers (or a dedicated service in a cloud-based environment) may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on one or more clients 202 (e.g., as a part of the resource access application 422), one or more servers 204, or one or more other system component(s). In general, the monitoring agents may execute transparently (e.g., in the background) to any application and/or user of the device. In some embodiments, such a monitoring agent may be implemented as components of Citrix Analytics™ by Citrix Systems, Inc., of Fort Lauderdale, FL.

The monitoring agents may, for example, monitor, measure, collect, and/or analyze data on a frequency (e.g., a predetermined frequency), based upon an occurrence of given event(s), or in real time during operation of the resource delivery system 500. The monitoring agents may, for example, monitor resource consumption and/or performance of hardware, software, and/or communications resources of the clients 202, the gateway 508 (and/or any other components in the DMZ 528), and/or the resource delivery controller(s) 512, the shared computing resources 502, the resource delivery agents 504, or any other components shown in FIG. 5A. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents may provide application performance management for the resource delivery system 500. For example, based upon one or more monitored performance conditions or metrics, the resource delivery system 500 may be dynamically adjusted, for example periodically or in real-time, to optimize application delivery by the resource delivery agents 504 to the clients 202 based upon network environment performance and conditions

FIG. 5B illustrates an example deployment 530 of a resource delivery system 500, such as that shown in FIG. 5A. Such a deployment may be referred to as a “Site.” A Site may be made up of machines with dedicated roles that allow for scalability, high availability, and failover, and may provide a solution that is secure by design. As discussed above, such a Site may include servers and/or desktop machines installed with resource delivery agents 504, and one or more resource delivery controller(s) 512, which may manage access to such servers/machines. FIG. 5B illustrates one such resource delivery agent 504, and one such resource delivery controller 512. As shown in FIG. 5B, the resource delivery controller 512 may include a broker service 532. The resource delivery agent 504 may enable users to connect to desktops and/or applications. It may be installed on server or desktop machines in a datacenter for most delivery methods, but it may also be installed on physical personal computers (PCs) for Remote PC Access. In some implementations, the resource delivery controller 512 may be made up of independent Windows services that may manage resources, applications, and/or desktops, and may optimize and balance user connections.

In some embodiments, client devices 202 may not directly access the resource delivery controller 512. Instead, the resource delivery agent 504 and the client access manager 510 may serve as intermediaries between client devices 202 and the resource delivery controller 512. When users log on using the client access manager 510, their credentials may pass through to the broker service 532 on the resource delivery controller 512. The broker service 532 may then obtain profiles and available resources based on the policies set for them.

FIG. 5C illustrates an example process for handling user connections within the deployment 530 shown in FIG. 5B. As indicated by arrows 534 and 535, to start a session, a user may cause the client device 202 to connect (via the gateway 508) to the client access manager 510. Such a connection may, for example, be established using the resource access application 422. As noted above, the resource access application 422 may either be installed on the client device 202 or accessible from a web server via a web browser on the client device 202.

As indicated by arrow 536, the user's credentials may then move through this pathway to access the broker service 532 of resource delivery controller 512. In some implementations, such communications may be encrypted to protect the security of such credentials. The broker service 532 may determine which desktops and/or applications the user is allowed to access. After the credentials have been verified, information about available applications and/or desktops may be sent back to the client device 202 through the pathway between the client access manager 510 and the resource access application 422, as indicated by arrows 538, 540, and 541. The user of the client device 202 may thus be provided with a list of available applications and/or desktops. When the user selects an application or desktop from this list, an indication of the selected resource goes back down the previously described pathway to the resource delivery controller 512. The resource delivery controller 512 may then select an appropriate resource delivery agent 504 to host the selected applications or desktop.

As indicated by arrow 542, the resource delivery controller 512 may send a message to the selected resource delivery agent 504 with the user's credentials, and may then send pertinent data about the user and the connection to the resource delivery agent 504. The resource delivery agent 504 may then accept the connection and, as indicated by arrows 544, 538, 540, and 541, may send a set of access parameters (stored in an access parameter stack 546a) back through the same pathways to the resource access application 422. In particular, the set of access parameters may be collected by the client access manager 510 and then sent to the resource access application 422 where they may be stored as an access parameter file 546b. In some implementations, the access parameter file 546b may be created as part of a protocol conversation between the client access manager 510 and the resource access application 422. In other implementations, the client access manager 510 may convert the access parameters to the file 546b, and that file 546b may then be downloaded to the client device 202. In some implementations, the access parameters may remain encrypted throughout this process.

The access parameter file 546b that is then stored on the client device 202 may be used to establish a direct connection 548 between the client device 202 and the access parameter stack 546a running on the resource delivery agent 504. As illustrated, the connection 548 between the client device 202 and the resource delivery agent 504 may use a gateway protocol 550. In some implementations, the gateway protocol 550 may include a feature that enables the client device 202 to immediately reconnect to the resource delivery agent 504 if the connection 548 is lost, rather than having to relaunch through the management infrastructure (including the client access manager 510, the resource delivery controller 512, etc.).

After the client device 202 connects to the resource delivery agent 504, the resource delivery agent 504 may notify the resource delivery controller 512 that the user is logged on. The resource delivery controller 512 may then send this information to the database(s) 520 (shown in FIGS. 5A, 5B and 5D) and the monitor service 560 (shown in FIG. 5D) of the delivery controller 512 may also start logging data in the database(s) 520.

Such sessions between client devices 202 and resource delivery agents 504 produce data that system administrators can access through the resource manager 514 and/or the resource director 516. FIG. 5D shows examples of paths through which the resource manager 514 and the resource director 516 may access such data in some embodiments. As indicated by the arrows 552 and 554, administrators may use the resource manager 514 to access real-time data from the broker agent 556 of a resource delivery agent 504 (via the broker service 532 of the resource delivery controller 512). The resource director 516 may access the same data, as indicated by arrows 558 and 554, plus any historical data the monitor service 560 of the resource delivery controller 512 stores in the database(s) 520, as indicated by arrows 558, 562 and 564. Further, as indicated by arrow 566, the resource director 516 may also access data from the gateway 508 for help desk support and troubleshooting.

Within the resource delivery controller 512, the broker service 532 may report session data for every session on the machine providing real-time data. The monitor service 560 may also track the real-time data and store it as historical data in the database(s) 520. In some implementations, the resource manager 514 may communicate with the broker service 532 and may access real-time data. The resource director 516 may communicate with the broker service 532 to access the database(s) 520.

An example process for enabling the delivery of applications and/or desktops will now be described. First, the machines that are to deliver applications and/or desktops may be set up with “Machine Catalogs.” Then, “Delivery Groups” may be created that specify the applications and/or desktops that are to be made available (using machines in the Machine Catalogs), and which users can access them. In some implementations, “Application Groups” may also be created to manage collections of applications.

Machine Catalogs are collections of virtual or physical machines that can be managed as a single entity. These machines, and the application and/or virtual desktops on them, are the resources that may be made available to users. All the machines in a Machine Catalog may have the same operating system and the same resource delivery agent 504 installed. They may also have the same applications and/or virtual desktops.

In some implementations, a master image may be created and used to create identical virtual machines in the catalog. For virtual machines, the provisioning method may be specified for the machines in that catalog. Valid machine types may, for example, include “Multi-session OS,” “Single-session OS,” and “Remote PC access.” A Multi-session OS machine is a virtual or physical machine with a multi-session operating system. Such a machine may be used to deliver published applications (also known as server-based hosted applications) and published desktops (also known as server-hosted desktops). These machines may allow multiple users to connect to them at one time. A Single-session OS machine is a virtual or physical machine with a single-session operating system. Such a machine may be used to deliver Virtual Desktop Infrastructure (VDI) desktops (desktops running single-session OSs that can optionally be personalized), virtual machine (VM)-hosted apps (applications from single-session OSs), and hosted physical desktops. Only one user at a time can connect to each of these desktops. A Remote PC access machine may enable remote users to access their physical office PCs from any device running the resource access application 422.

Delivery Groups may specify which users can access which applications and/or desktops on which machines. Delivery Groups may include machines from the Machine Catalogs, and Active Directory users who have access to the Site. In some implementations, users may be assigned to Delivery Groups by their Active Directory group, because Active Directory groups and Delivery Groups are ways to group users with similar requirements.

Delivery Groups may contain machines from more than one Machine Catalog, and Machine Catalogs may contribute machines to more than one Delivery Group. In at least some implementations, however, individual machines can only belong to one Delivery Group at a time.

The specific resources that users in the Delivery Group can access may be defined. For example, to deliver different applications to different users, all of the applications may be installed on the master image for one Machine Catalog and enough machines may be created in that catalog to distribute among several Delivery Groups. Delivery Groups may then be configured to deliver a different subset of applications that are installed on the machines.

Application Groups may provide application management and resource control advantages over using more Delivery Groups. Using a “tag restriction” feature, existing machines may be used for more than one “publishing” task, saving the costs of deployment and managing additional machines. A tag restriction can be thought of as subdividing (or partitioning) the machines in a Delivery Group. Application Groups may also be helpful when isolating and troubleshooting a subset of machines in a Delivery Group.

“Tags” may be strings that identify items such as machines, applications, desktops, Delivery Groups, Application Groups, and policies. After creating a tag and adding it to an item, certain operations may be tailored to apply to only items that have a specified tag.

In some implementations, tags may be used to tailor search displays is the resource manager 514. For example, to display only applications that have been optimized for testers, a tag named “test” may be created and may then be added (applied) to those applications. A search performed by the resource manager 514 may then be filtered with the tag “test”.

In some implementations, tags may be used to “publish” applications from an Application Group or specific desktops from a Delivery Group, considering only a subset of the machines in selected Delivery Groups. Using an Application Group or desktops with a tag restriction may be helpful when isolating and troubleshooting a subset of machines in a Delivery Group.

In some implementations, tags may be used to schedule periodic restarts for a subset of machines in a Delivery Group. Using a tag restriction for machines may, for example, enable the use of new PowerShell cmdlets to configure multiple restart schedules for subsets of machines in a Delivery Group.

In some implementations, tags may be used to tailor the application (assignment) of particular policies to a subset of machines in Delivery Groups, Delivery Group types, or organizational units (OUs) of a Site that have (or do not have) a specified tag. For example, if a particular policy is to be applied only to the more powerful workstations, a tag named “high power” may be applied to those machines and the policy may be set to apply to only machines to which the high power tag has been applied. Tags may additionally or alternatively be applied to particular Delivery Groups and one or more policies may be set to apply only the Delivery Groups to which such tags have been applied.

In some embodiments, the resource manager 514 may be used to create or edit a tag restriction for a desktop in a shared Delivery Group or an Application Group. In some implementations, creating such a tag restriction may involve several steps. First, a tag may be created and then added (applied) to one or more machines. Second a group may be created or edited to include the tag restriction, thus restricting launches to machines with the applied tag. A tag restriction may extend the machine selection process of the broker service 532. In particular, the broker service 532 may select a machine from an associated Delivery Group subject to access policy, configured user lists, zone preference, and launch readiness, plus the tag restriction (if present). For applications, the broker service 532 may fall back to other Delivery Groups in priority order, applying the same machine selection rules for each considered Delivery Group.

FIG. 5E illustrates a simple layout in which tag restrictions may be used to limit which machines will be considered for certain desktop and application launches. In the illustrated example, a site 576 has one shared Delivery Group 578 configured with three machines 580, 582, 584 and one published desktop 586, and one Application Group 588 configured with two applications 590, 592. As shown, tags may be added to each of the three machines 580, 582, 584. A tag restriction named “Red” has been applied to the published desktop 586 in the shared Delivery Group 578, so that the published desktop 586 can be launched only on machines in that Delivery Group 578 that have the tag “Red,” i.e., the machines 580 and 582. A tag restriction named “Orange” has been applied to the Application Group 588, so that each of its applications 590, 592 (Calculator and Notepad) can be launched only on machines in the Delivery Group 578 that have the tag “Orange,” i.e., the machines 582 and 584. Since the machine 582 has both tags (Red and Orange), it can be considered for launching the applications 590, 592 and the desktop 586.

In some implementations, tags may be created, added (applied), edited, and/or deleted from selected items using the resource manager 514. Tag restrictions may, for example, be configured when creating or editing desktops in Delivery Groups and/or when creating or editing Application Groups.

As noted above, the resource delivery system 500 described in connection with FIGS. 5A-5D may provide virtualization solutions that give administrators control of virtual machines, applications, and security while providing anywhere access for any device. As was also noted above, the resource delivery system 500 may also enable end users to access applications and desktops independently of the operating systems and interfaces of the client devices 202 such end users are operating.

In some implementations, one or more components of the resource delivery system 500 may be provided as a service within a cloud-based computing environment. FIG. 5F illustrates an example of such an implementation. As shown in FIG. 5F, one or more cloud connectors 568 may enable various resources at one or more locations 570 outside of a cloud computing environment 572 to interface with various components within the cloud computing environment 572. As illustrated, resource location(s) 570 may include the machines and other resources that deliver applications and/or desktops to client devices 202. As indicated by dashed lines, the resource location 570 may optionally include the gateway 508 and/or the client access manager 510 previously described. In the illustrated example, the resource delivery controller(s) 512, the resource manager 514, the resource director 516, the license manager 518, and the database(s) 520 are all provided within the cloud computing environment 572. Further, as shown in FIG. 5F, a configuration manager 574 may additionally be hosted within the cloud computing environment 572 in some implementations. Examples of management functions that may be performed by the configuration manager 574 are described below. In some implementations, the cloud computing environment 572 may correspond to a public cloud computing infrastructure, such as AZURE CLOUD provided by Microsoft Corporation of Redmond, Washington, or AMAZON WEB SERVICES provided by Amazon.com, Inc., of Seattle, Washington.

In addition to serving as a channel for communication between the cloud computing environment 572 and the resource location(s) 570, the cloud connectors 568 may enable cloud management without requiring any complex networking or infrastructure configuration such as virtual private networks (VPNs) or Internet Protocol Security (IPsec) tunnels.

As noted above, the resource delivery controller(s) 512 may serve as the central control layer component in a deployment. The resource delivery controller(s) 512 may communicate through the cloud connectors 568 in each resource location 570 to distribute applications and/or desktops, authenticate and manage user access, broker connections between users and their virtual desktops and/or applications, optimize use connections, and/or load-balance use connections. In some implementations, the resource delivery controller(s) 512 may additionally track which users are logged on and where, which session resources the users have, and if users need to reconnect to existing applications. The resource delivery controller(s) 512 may further manage the state of desktops, starting and stopping them based on demand and administrative configuration, in some implementations.

The configuration manager 574 in the cloud computing environment 572 may (A) enable administrators to specify which services are to be made available to users via the resource access application, (B) customize the uniform resource locator (URL) that the resource access application 422 is to use to access the available resources, (C) customize the appearance of the user interface provided by the resource access application, such as logos, color, and preferences, (D) specify how users are to authenticate to the system, such as using the Active Directory 522, and/or (E) specify external connectivity for the resource locations 570.

As noted above, a resource location 570 may include at least one cloud connector 568 that serves as the communications channel between the components in the cloud computing environment 572 and the components in the resource location 570. In the resource location 570, the cloud connector(s) may act as a proxy for the resource delivery controller(s) 512 in the cloud computing environment 572.

As noted above, the physical or virtual machines that deliver applications and/or desktops may include resource delivery agents 504a, 504b. The resource delivery agents 504 may register with at least one cloud connector 568. After registration, connections may be brokered from those resources to users. The resource delivery agents 504 may further establish and manage the connection between the machine and the client device 202, and apply policies that are configured for the session. The resource delivery agents 504 may communicate session information to the cloud connector 568 through the broker agent 556 (shown in FIG. 5D) in the resource delivery agent 504. As noted above, in some implementations, such a broker agent 556 may host multiple plugins and collect real-time data.

A host connection may be established that enables communication between components in the cloud computing environment 572 and the resource delivery agents 504 on the shared computing resources 502. Specifications for such host connections may include (A) the address and credentials to access the host, (B) the tool that is to be used to create VMs, (C) the storage method to use, (D) the machines to use for storage, and/or (E) which network the VMs will use.

### F. Example Architecture of a Resource Virtualization Server

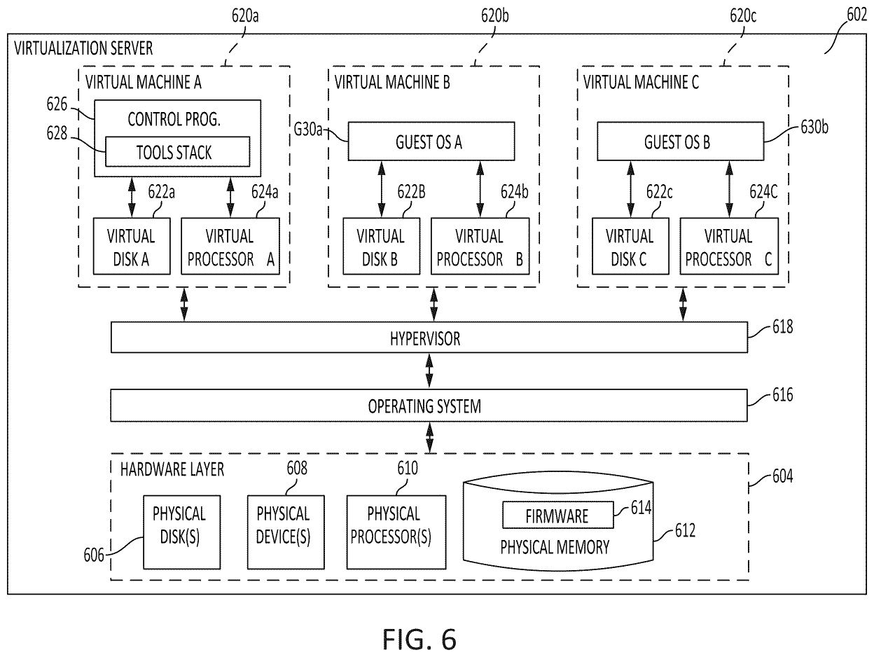

FIG. 6 shows an example architecture of an illustrative resource virtualization server 602. As shown, the resource virtualization server 602 may be configured to provide virtual desktops and/or virtual applications to one or more client access devices, such as the clients 202. As used herein, a desktop may refer to a graphical environment (e.g., a graphical user interface) or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Instances of the operating system may be physical (e.g., one operating system per physical device) or virtual (e.g., many instances of an OS running on a single physical device). The applications may be executed on a local device, or executed on a remotely located device (e.g., remoted).

The virtualization server 602 illustrated in FIG. 6 may be deployed as and/or implemented by one or more of the servers 204 described above, the servers that make up a virtualization server system, or by other known computing devices. Included in the virtualization server 602 is a hardware layer 604 that may include one or more physical disks 606, one or more physical devices 608, one or more physical processors 610, and one or more physical memories 612. In some embodiments, firmware 614 may be stored within a memory element in physical memory 612 and be executed by one or more of the physical processors 610. The virtualization server 602 may further include an operating system 616 that may be stored in a memory element in physical memory 612 and executed by one or more of physical processors 610. Still further, a hypervisor 618 may be stored in a memory element in the physical memory 612 and be executed by one or more of the physical processors 610. Presence of the operating system 616 may be optional such as in a case where the hypervisor 618 is a Type 1 hypervisor; that is, a bare-metal hypervisor installed directly on the hardware layer 604. In some implementations, the hypervisor 618 may be a Type 2 hypervisor, which executes on a host operating system, such as the OS 616, which may provide virtualization services such as I/O device support and memory management.

Executing on one or more of the physical processors 610 may be one or more virtual machines 620a-c (generally 620). The virtual machines 620 may have respective virtual disks 622a-c and virtual processors 624a-c. In some embodiments, a first virtual machine 620a may execute, using the virtual processor 624a, a control program 626 that includes a tools stack 628. The control program 626 may be referred to as a control virtual machine, Domain 0, Dom0, or other virtual machine used for system administration and/or control. In some embodiments, one or more of the virtual machines 620b-c may execute, using a virtual processor 624b-c, a guest operating system 630a-b (generally 630).

The physical devices 608 may include, for example, a network interface card, a video card, an input device (e.g., a keyboard, a mouse, a scanner, etc.), an output device (e.g., a monitor, a display device, speakers, a printer, etc.), a storage device (e.g., an optical drive), a Universal Serial Bus (USB) connection, a network element (e.g., router, firewall, network address translator, load balancer, virtual private network (VPN) gateway, Dynamic Host Configuration Protocol (DHCP) router, etc.), or any device connected to or communicating with virtualization server 602. The physical memory 612 in hardware layer 604 may include any type of memory. The physical memory 612 may store data, and in some embodiments may store one or more programs, or set of executable instructions. FIG. 6 illustrates an embodiment where firmware 614 is stored within physical memory 612 of virtualization server 602. Programs or executable instructions stored in physical memory 612 may be executed by the one or more of the processors 610 of the virtualization server 602.

The virtualization server 602 may also include hypervisor 618. In some embodiments, the hypervisor 618 may be a program executed by processors 610 on the virtualization server 602 to create and manage any number of virtual machines 620. The hypervisor 618 may be referred to as a virtual machine monitor, or platform virtualization software. In some embodiments, the hypervisor 618 may be any combination of executable instructions and hardware that monitors virtual machines 620 executing on a computing machine. The hypervisor 618 may be a Type 2 hypervisor, where the hypervisor executes within operating system 616 executing on virtualization server 602. The virtual machines may then execute at a layer above hypervisor 618. In some embodiments, the Type 2 hypervisor may execute within the context of a user's operating system such that the Type 2 hypervisor interacts with the user's operating system. In other embodiments, one or more virtualization servers 602 in a virtualization environment may instead include a Type 1 hypervisor (not shown). A Type 1 hypervisor may execute on the virtualization server 602 by directly accessing the hardware and resources within hardware layer 604. That is, while the Type 2 hypervisor 618 accesses system resources through host operating system 616, as shown, a Type 1 hypervisor may directly access all system resources without host operating system 616. A Type 1 hypervisor may execute directly on one or more physical processors 610 of the virtualization server 602, and may include program data stored in the physical memory 612.

The hypervisor 618, in some embodiments, may provide virtual resources to the guest operating systems 630 or control programs 626 executing on virtual machines 620 in any manner that simulates the operating systems 630 or control programs 626 having direct access to system resources. System resources may include, but are not limited to, the physical devices 608, the physical disks 606, the physical processors 610, physical memory 612, and any other component included in the hardware layer 604 of the virtualization server 602. The hypervisor 618 may be used to emulate virtual hardware, partition physical hardware, virtualize physical hardware, and/or execute virtual machines that provide access to computing environments. In still other embodiments, the hypervisor 618 may control processor scheduling and memory partitioning for the virtual machine 620 executing on the virtualization server 602. Examples of hypervisor 618 may include those manufactured by VMWare, Inc., of Palo Alto, California; Xen Project® hypervisor, an open source product whose development is overseen by the open source XenProject.org community; Hyper-V®, Virtual Server®, and Virtual PC® hypervisors provided by Microsoft Corporation of Redmond, Washington; or others. In some embodiments, the virtualization server 602 may execute a hypervisor 618 that creates a virtual machine platform on which the guest operating systems 630 may execute. In these embodiments, the virtualization server 602 may be referred to as a host server. An example of such a virtualization server is Citrix Hypervisor® provided by Citrix Systems, Inc., of Fort Lauderdale, Florida.

The hypervisor 618 may create one or more virtual machines 620b-c (generally 620) in which guest operating systems 630 execute. In some embodiments, the hypervisor 618 may load a virtual machine image to create a virtual machine 620. The virtual machine image may refer to a collection of data, states, instructions, etc. that make up an instance of a virtual machine. In other embodiments, the hypervisor 618 may execute guest operating system 630 within the virtual machine 620. In still other embodiments, the virtual machine 620 may execute the guest operating system 630.

In addition to creating the virtual machines 620, the hypervisor 618 may control the execution of at least one virtual machine 620. In other embodiments, the hypervisor 618 may present at least one virtual machine 620 with an abstraction of at least one hardware resource provided by the virtualization server 602 (e.g., any hardware resource available within hardware layer 604). In other embodiments, the hypervisor 618 may control the manner in which the virtual machines 620 access physical processors 610 available in the virtualization server 602. Controlling access to the physical processors 610 may include determining whether the virtual machine 620 should have access to the processor 610, and how physical processor capabilities are presented to the virtual machine 620.

As shown in FIG. 6, the virtualization server 602 may host or execute one or more virtual machines 620. A virtual machine 620 may be a set of executable instructions and/or user data that, when executed by processor 610, may imitate the operation of a physical computer such that the virtual machine 620 may execute programs and processes much like a physical computing device. While FIG. 6 illustrates an embodiment where the virtualization server 602 hosts three virtual machines 620, in other embodiments the virtualization server 602 may host any number of virtual machines 620. The hypervisor 618, in some embodiments, may provide the virtual machines 620 with unique virtual views of the physical hardware, including the memory 612, the processor 610, and other system resources 606, 608 available to the respective virtual machines 620. In some embodiments, the unique virtual view may be based on one or more of virtual machine permissions, application of a policy engine to one or more virtual machine identifiers, a user accessing a virtual machine, the applications executing on a virtual machine, networks accessed by a virtual machine, or any other desired criteria. For instance, the hypervisor 618 may create one or more unsecure virtual machines 620 and one or more secure virtual machines 620. The unsecure virtual machines 620 may be prevented from accessing resources, hardware, memory locations, and programs that the secure virtual machines 620 may be permitted to access. In other embodiments, the hypervisor 618 may provide the virtual machines 620 with substantially similar virtual views of the physical hardware, memory, processor, and other system resources available to the virtual machines 620.

The virtual machines 620 may include respective virtual disks 622a-c (generally 622) and virtual processors 624a-c (generally 624.) The virtual disk 622, in some embodiments, may be a virtualized view of one or more physical disks 606 of the virtualization server 602, or a portion of one or more physical disks 606 of the virtualization server 602. The virtualized view of the physical disks 606 may be generated, provided, and managed by the hypervisor 618. In some embodiments, the hypervisor 618 may provide the virtual machines 620 with unique views of the physical disks 606. Thus, in these embodiments, a particular virtual disk 622 included in a respective virtual machine 620 may be unique when compared with other virtual disks 622.

The virtual processor 624 may be a virtualized view of one or more physical processors 610 of the virtualization server 602. In some embodiments, the virtualized view of physical processors 610 may be generated, provided, and managed by the hypervisor 618. In some embodiments, the virtual processor 624 may have substantially all of the same characteristics of at least one physical processor 610. In other embodiments, the virtual processor 610 may provide a modified view of the physical processors 610 such that at least some of the characteristics of the virtual processor 624 are different from the characteristics of the corresponding physical processor 610

### G. Detailed Description of Example Embodiments of the System for Providing Isolated Clipboard Regions for Particular Applications and/or Groups of Applications Introduced in Section A

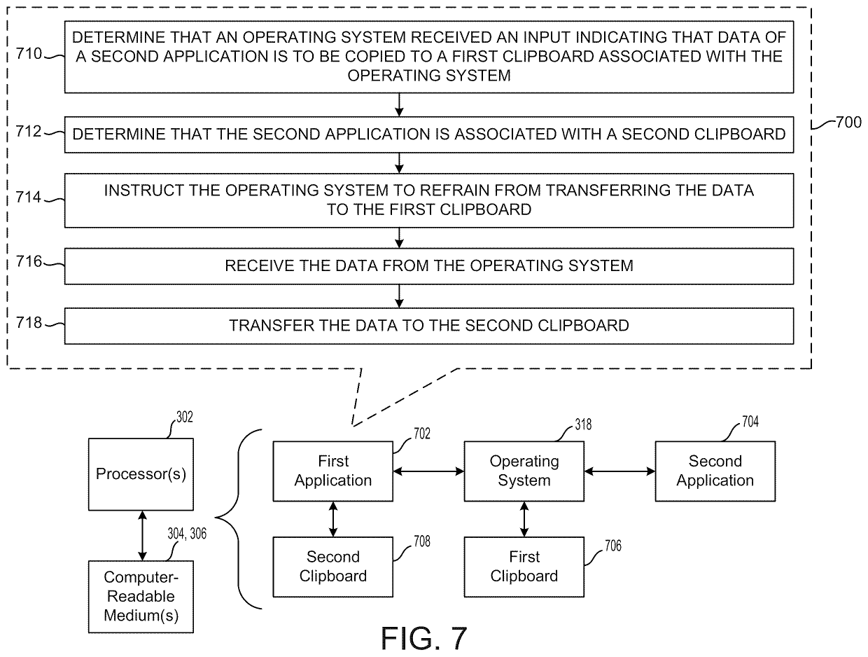

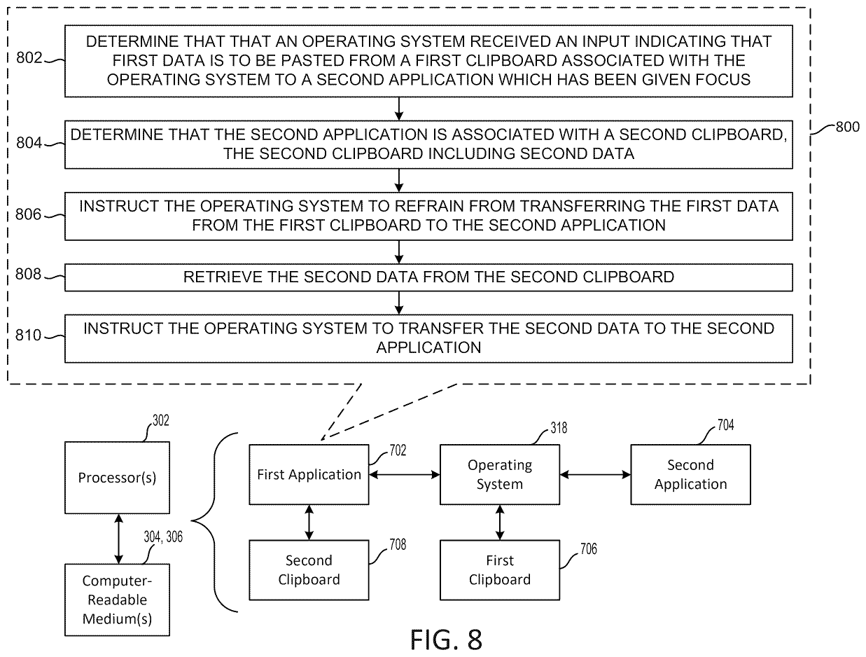

FIGS. 7 and 8 illustrate example routines 700, 800 that may be performed by a first application 702, such as the resource access application 422 described in Sections D and E or another application that embodies the clipboard management engine 102 described in connection with FIGS. 1A and 1B. As shown in FIGS. 7 and 8, in some implementations, the first application 702, as well as the other illustrated components (i.e., an operating system 318, a first clipboard 706 associated with the operating system 318, a second application 704, and a second clipboard 708 managed by the first application 702) may be implemented, in whole or in part, by one or more processors 302 and one or more computer-readable media 304, 306 of a computing system 300 of the type described in Section C.

In some implementations, the first application 702 may correspond to the clipboard management engine 102 shown in FIGS. 1A and 1B, the second application 704 may correspond to one of the applications 104 shown in FIGS. 1A and 1B, the operating system 318 may correspond to the operating system 106 shown in FIGS. 1A and 1B, the first clipboard 706 may correspond to the operating system clipboard 112 shown in FIGS. 1A and 1B, and the second clipboard 708 may correspond to the private clipboard 110 shown in FIGS. 1A and 1B. Similar to FIGS. 1A and 1B, the routine 700 of FIG. 7 corresponds to a scenario in which the operating system 318 receives a request to copy data from the second application 704 to the first clipboard 706, and the routine 800 of FIG. 8 corresponds to a scenario in which the operating system 318 receives a request to paste data from the first clipboard 706 to the second application 704.

The routine 700 shown in FIG. 7 will now be described. Examples of code modules 900, 1000 that may be executed by the first application 702 to perform the routine 700 are described below in connection with FIGS. 9A and 10A, with the code module 900 of FIG. 9A being usable where the second application 704 is a SaaS application, and the code module 1000 of FIG. 10A being usable where the second application 704 is any type of application.

As shown in FIG. 7, at a step 710 of the routine 700, the first application 702 (e.g., the resource access application 422 described in Sections D and E or another application that embodies the clipboard management engine 102 described in connection with FIGS. 1A and 1B) may determine that the operating system 318 received an input indicating that data of the second application 704 is to be copied to the first clipboard 706, i.e., the clipboard that is normally used by the operating system 318. Such a request may, for example, be a copy request (e.g., via a CNTL-X or CNTL-C command) that is received by the operating system 318 while a data item of the second application 704 (e.g. a text block, an image, a document, etc.) is in a selected state. As noted in Section A, and as further described below in connection with FIGS. 9A and 10A, in some implementations, the first application 702 may use one or more API commands to detect the occurrence of such requests.

At a step 712 of the routine 700, the first application 702 may determine that the second application 704 is associated with the second clipboard 708. As described in Section A, for example, in some implementations, the first application 702 may identify such an association by determining that an identifier of the second application 704 (e.g., an application type identifier in a table, such as the table 114 shown in FIGS. 1A and 1B) is stored in association with an identifier of a particular region of the second clipboard 708 (e.g., a group ID in the table 114).

At a step 714 of the routine 700, the first application 702 may instruct the operating system 318 to refrain from transferring the selected data to the first clipboard 706. For example, as noted in Section A, and as further described below in connection with FIGS. 9A and 10A, in some implementations, the first application 702 may use one or more API commands to instruct the operating system 318 to abort the requested copy operation to its clipboard 706.

At a step 716 of the routine 700, the first application 702 may receive the selected data from the operating system 318. For example, as noted in Section A, and as further described below in connection with FIGS. 9A and 10A, in some implementations, the first application 702 may use one or more API commands to cause the operating system 106 to return the data that has been selected within the second application 704.

At a step 718 of the routine 700, the first application 702 may transfer the received data to the second clipboard 708. As described in Section A, for example, in some implementations, the first application 702 may write the data to a region of the second clipboard 708 that corresponds to a group ID associated with the second application 104 in a table (e.g., the table 114 shown in FIGS. 1A and 1B).

The routine 800 shown in FIG. 8 will now be described. Examples of code modules 950, 1050 that may be executed by the first application 702 to perform the routine 800 are described below in connection with FIGS. 9B and 10B, with the code module 950 of FIG. 9B being usable where the second application 704 is a SaaS application, and the code module 1050 of FIG. 10B being usable where the second application 704 is any type of application.

As shown in FIG. 8, at a step 802 of the routine 800, the first application 702 may determine that that the operating system 318 received an input indicating that first data is to be pasted from a first clipboard 706 associated with the operating system 318 to a second application 704 which has been given focus. For example, as noted in Section A, and as further described below in connection with FIGS. 9B and 10B, in some implementations, the first application 702 may use one or more API commands to detect the occurrence of such a paste request.

At a step 804 of the routine 800, the first application 702 may determine that the second application 704 is associated with a second clipboard 708, the second clipboard 708 including second data. As described in Section A, for example, in some implementations, the first application 702 may identify such an association by determining that an identifier of the second application 704 (e.g., an application type identifier in a table, such as the table 114 shown in FIGS. 1A and 1B) is stored in association with an identifier of a particular region of the second clipboard 708 (e.g., a group ID in the table 114).

At a step 806 of the routine 800, the first application 702 may instruct the operating system 318 to refrain from transferring the first data from the first clipboard 706 to the second application 704. For example, as noted in Section A, and as further described below in connection with FIGS. 9B and 10B, in some implementations, the first application 702 may use one or more API commands to instruct the operating system 318 to abort the requested paste operation from its clipboard 706.

At a step 808 of the routine 800, the first application 702 may retrieve the second data from the second clipboard 708. For example, in some implementations, the first application 702 may retrieve the second data from a particular region of the second clipboard 708 corresponding to a group ID associated with the second application 704 (e.g., via an entry of a table, such as the table 114 shown in FIGS. 1A and 1B).

At a step 810 of the routine 800, the first application 702 may instruct the operating system 318 to transfer the second data to the second application 704. For example, as noted in Section A, and as further described below in connection with FIGS. 9B and 10B, in some implementations, the first application 702 may use one or more API commands to instruct the operating system 318 to transfer the second data to a component of the second application 704 which has been given focus.

As noted above, in some implementations, the example code modules 900 and 950 shown in FIGS. 9A and 9B, respectively, may be employed by the clipboard management engine 102 shown in FIGS. 1A and 1B in embodiments in which the application(s) 104 are SaaS applications. Likewise, as also noted above, in some implementations, the example code modules 900 and 950 shown in FIGS. 9A and 9B, respectively, may be employed by the first application 702 shown in FIGS. 7 and 8 in embodiments in which the second application 704 is a SaaS application. In some implementations, the code modules 900 and 950 may be written using JavaScript.

The code module 900 shown in FIG. 9A will now be described. As noted previously, the code module 900 may be executed by the clipboard management engine 102 (shown in FIG. 1A) and/or the first application 702 (shown in FIG. 7) to perform the process illustrated in FIG. 1A and/or to perform the routine 700 shown in FIG. 7.

As shown in FIG. 9A, the code module 900 may include an instruction 902 to hook onto a copy event (with may involve either a “copy” command or a “cut” command) of the operating system 106, 318 associated with the SaaS application 104, 704, and to take certain actions in response to the detection of such a copy event. In some implementations, the instruction 902 may thus cause the occurrence of the step A2 illustrated in FIG. 1A and/or the step 710 of the routine 700 shown in FIG. 7.

As illustrated, in some implementations, the code module 900 may further include an instruction 904 that imposes a condition that causes the subsequent actions to be performed only if the clipboard management engine 102/first application 702 determines that the requesting SaaS application 104, 704 is within a managed group, e.g., by determining that an identifier of the SaaS application 104, 704 is associated with a group ID within the table 114 (shown in FIG. 1A). As indicated, the variable “X1” in the code module 900 may represent one or more instructions that may be executed to make such a determination. In some implementations, the instruction 904 may thus cause the performance of the step A3 illustrated in FIG. 1A and/or the step 712 of the routine 700 shown in FIG. 7.

As shown in FIG. 9A, the code module 900 may further include instructions 906, 908, 910, and 912 that are to be executed if the condition specified by the instruction 904 is met.

The instruction 906 may cause the operating system 106, 318 to abort the requested copy operation. In some implementations, the instruction 906 may thus cause the performance of the steps A4 and A5 illustrated in FIG. 1A and/or the step 714 of the routine 700 shown in FIG. 7.

The instruction 908 may cause the operating system 106, 318 to determine and return the content of the SaaS application 104, 704 that has been selected. In some implementations, the instruction 908 may thus cause the performance of the step A6 illustrated in FIG. 1A and/or the step 716 of the routine 700 shown in FIG. 7.

The instruction 910 may cause the clipboard management engine 102/first application 702 to convert the returned content into a string format.

Finally, the instruction(s) 912 represented by the variable “Y1” may cause the clipboard management engine 102/first application 702 to determine the group ID that is associated with the SaaS application 104, 704 (e.g., by referencing the table 114 shown in FIG. 1A), and to write the selected content from the SaaS application (as a string) to the region of the private clipboard 110/second clipboard 708 corresponding to that group ID. In some implementations, the instruction(s) 912 may thus cause the performance of the steps A7 and A8 illustrated in FIG. 1A and/or the step 718 of the routine 700 shown in FIG. 7.

The code module 950 shown in FIG. 9B will now be described. As noted previously, the code module 950 may be executed by the clipboard management engine 102 (shown in FIG. 1A) and/or the first application 702 (shown in FIG. 7) to perform the process illustrated in FIG. 1B and/or to perform the routine 800 shown in FIG. 8.

As shown in FIG. 9B, the code module 950 may include an instruction 952 to hook onto a paste event of the operating system 106, 318 associated with the SaaS application 104, 704, and to take certain actions in response to the detection of such a paste event. In some implementations, the instruction 952 may thus cause the performance of the step B2 illustrated in FIG. 1B and/or the step 802 of the routine 800 shown in FIG. 8.

As illustrated, in some implementations, the code module 950 may further include an instruction 954 that imposes a condition that causes the subsequent actions to be performed only if the clipboard management engine 102/first application 702 determines that the requesting SaaS application 104, 704 is within a managed group, e.g., by determining that an identifier of the SaaS application 104, 704 is associated with a group ID within the table 114 (shown in FIG. 1B). As indicated, the variable “X2” in the code module 950 may represent one or more instructions that may be executed to make such a determination. In some implementations, the instruction 954 may thus cause the performance of the step B3 illustrated in FIG. 1B and/or the step 804 of the routine 800 shown in FIG. 8.

As shown in FIG. 9B, the code module 950 may further include instructions 956, 958, 960, 962, 964 and 966 that are to be executed if the condition specified by the instruction 954 is met.

The instruction 956 may cause the operating system 106, 318 to abort the requested paste operation. In some implementations, the instruction 956 may thus cause the performance of the steps B4 and B5 illustrated in FIG. 1B and/or the step 806 of the routine 800 shown in FIG. 8.

The instruction(s) 958 may cause the clipboard management engine 102/first application 702 to retrieve data from the region of the private clipboard 110/second clipboard 708 corresponding to the group ID for the SaaS application 104, 704. As indicated, the variable “Y2” in FIG. 9B may, for example, represent one or more instructions that cause the clipboard management engine 102/first application 702 to determine the group ID that is associated with the SaaS application 104, 704 (e.g., by referencing the table 114 shown in FIG. 1B), and to retrieve the data from the region of the private clipboard 110/second clipboard 708 corresponding to that group ID. In some implementations, the instruction(s) 958 may thus cause the performance of the steps B6 and B7 illustrated in FIG. 1B and/or the step 808 of the routine 800 shown in FIG. 8.

The instructions 960, 962, 964, and 966 may cause the operating system 106, 318 to delete any currently selected content within the SaaS application 104, 704, and to write the data retrieved from the private clipboard 110/second clipboard 708 (which data is represented by the variable “paste” per the instruction 958) to the beginning of the selected region within the SaaS application (or to the location of the cursor if no content was selected within the SaaS application 104, 704). In some implementations, the instruction(s) 960, 962, 964, and 966 may thus cause the performance of the steps B8 and B9 illustrated in FIG. 1B and/or the step 810 of the routine 800 shown in FIG. 8.

As noted above, in some implementations, the example code modules 1000 and 1050 shown in FIGS. 10A and 10B, respectively, may be employed by the clipboard management engine 102 shown in FIGS. 1A and 1B in embodiments in which the application(s) 104 are any type of applications, and not necessarily SaaS applications. Likewise, as also noted above, in some implementations, the example code modules 1000 and 1050 shown in FIGS. 10A and 10B, respectively, may be employed by the first application 702 shown in FIGS. 7 and 8 in embodiments in which the second application 704 is any type of application, and not necessarily a SaaS application.

The code module 1000 shown in FIG. 10A will now be described. As noted previously, the code module 1000 may be executed by the clipboard management engine 102 (shown in FIG. 1A) and/or the first application 702 (shown in FIG. 7) to perform the process illustrated in FIG. 1A and/or to perform the routine 700 shown in FIG. 7.

As shown in FIG. 10A, the code module 1000 may include an instruction 1002 to hook into the message loop of the operating system 106, 318 (e.g., Windows) associated with an application 104, 704, as well as an instruction 1004 to determine whether a message indicates that a copy event (which may involve either a “copy” command or a “cut” command) has occurred. As shown, certain actions may be taken if a copy event is identified. In some implementations, the instruction 1002, 1004 may thus cause the performance of the step A2 illustrated in FIG. 1A and/or the step 710 of the routine 700 shown in FIG. 7.

As illustrated, in some implementations, the instruction 1004 may additionally impose a condition that causes the noted actions to be performed only if the clipboard management engine 102/first application 702 determines that the requesting application 104, 704 is within a managed group, e.g., by determining that an identifier of the application 104, 704 is associated with a group ID within the table 114 (shown in FIG. 1A). As indicated, the variable “X3” in the code module 1000 may represent one or more instructions that may be executed to make such a determination. Accordingly, in some implementations, the instruction(s) represented by the variable “X3” may thus cause the performance of the step A3 illustrated in FIG. 1A and/or the step 712 of the routine 700 shown in FIG. 7.

As shown in FIG. 10A, the code module 1000 may further include instructions 1006 and 1008 that are to be executed if the conditions specified by the instruction 1004 are satisfied. If the conditions specified by the instruction 1004 are not met, then, per an “else” statement 1010, an instruction 1012 may be executed to cause the operating system 106, 318 to continue performing its normal, default operations corresponding to the message, such as by copying the selected data to the operating system clipboard 112/first clipboard 706. Notably, the actions 1006, 1008 that are performed if the conditions specified by the instruction 1004 are met do not include the instruction 1012. As such, if the conditions specified by the instruction 1004 are met, the operating system 106, 318 will not perform the requested copy operation, thus effectively aborting that operation. In some implementations, the absence of the instruction 1012 among the conditional actions 1006, 1008 shown in FIG. 10A may thus cause the performance of the steps A4 and A5 illustrated in FIG. 1A and/or the step 714 of the routine 700 shown in FIG. 7.

The instruction 1006 in the code module 1000 may cause the operating system 106, 318 to determine and return the content of the application 104, 704 that has been selected. In some implementations, the instruction 1006 may thus cause the performance of the step A6 illustrated in FIG. 1A and/or the step 716 of the routine 700 shown in FIG. 7.

Finally, the instruction(s) 1008 represented by the variable “Y3” may cause the clipboard management engine 102/first application 702 to determine the group ID that is associated with the requesting application 104, 704 (e.g., by referencing the table 114 shown in FIG. 1A), and to write the selected content from the application 104, 704 to the region of the private clipboard 110/second clipboard 708 corresponding to that group ID. In some implementations, the instruction(s) 1008 may thus cause the performance of the steps A7 and A8 illustrated in FIG. 1A and/or the step 718 of the routine 700 shown in FIG. 7.

The code module 1050 shown in FIG. 10B will now be described. As noted previously, the code module 1050 may be executed by the clipboard management engine 102 (shown in FIG. 1B) and/or the first application 702 (shown in FIG. 8) to perform the process illustrated in FIG. 1B and/or to perform the routine 800 shown in FIG. 8.

As shown in FIG. 10B, the code module 1050 may include an instruction 1052 to hook into the message loop of the operating system 106, 318 (e.g., Windows) associated with an application 104, 704, as well as an instruction 1054 to determine whether a message indicates that a paste event has occurred. As shown, certain actions may be taken if a paste event is identified. In some implementations, the instructions 1052, 1054 may thus cause the performance of the step B2 illustrated in FIG. 1B and/or the step 802 of the routine 800 shown in FIG. 8.

As illustrated, in some implementations, the instruction 1054 may additionally impose a condition that causes the noted actions to be performed only if the clipboard management engine 102/first application 702 determines that the requesting application 104, 704 is within a managed group, e.g., by determining that an identifier of the application 104, 704 is associated with a group ID within the table 114 (shown in FIG. 1B). As indicated, the variable “X4” in the code module 1050 may represent one or more instructions that may be executed to make such a determination. Accordingly, in some implementations, the instruction(s) represented by the variable “X4” may thus cause the performance of the step B3 illustrated in FIG. 1B and/or the step 804 of the routine 800 shown in FIG. 8.

As shown in FIG. 10B, the code module 1050 may further include one or more instructions 1056 (represented by the variable “Y4”) as well as one or more instruction blocks 1058, 1060 that are to be executed if the conditions specified by the instruction 1054 are met. If the conditions specified by the instruction 1054 are not met, then, per an “else” statement 1062, an instruction 1064 may be executed to cause the operating system 106, 318 to continue performing its normal, default operations corresponding to the message, such as by pasting the data from the operating system clipboard 112/first clipboard 706 to the requesting application 104, 704. Notably, the actions that are performed if the conditions specified by the instruction 1054 are met do not include the instruction 1064. As such, if the conditions specified by the instruction 1054 are met, the operating system 106, 318 will not perform the requested paste operation, thus effectively aborting that operation. In some implementations, the absence of the instruction 1064 among the conditional actions shown in FIG. 10B may thus cause the performance of the steps B4 and B5 illustrated in FIG. 1B and/or the step 806 of the routine 800 shown in FIG. 8.

The instruction(s) 1056 may cause the clipboard management engine 102/first application 702 to retrieve data from the region of the private clipboard 110/second clipboard 708 corresponding to the group ID for the requesting application 104, 704. As indicated, the variable “Y4” in FIG. 10B may represent one or more instructions that cause the clipboard management engine 102/first application 702 to determine the group ID that is associated with the requesting application 104, 704 (e.g., by referencing the table 114 shown in FIG. 1B), and to retrieve the data from the region of the private clipboard 110/second clipboard 708 corresponding to that group ID. In some implementations, the instruction(s) 1056 may thus cause the performance of the steps B6 and B7 illustrated in FIG. 1B and/or the step 808 of the routine 800 shown in FIG. 8.

The instruction block 1058 may cause the operating system 106, 318 to write the data retrieved from the private clipboard 110/second clipboard 708 to a text box of the requesting application 104, 704) in the event that focus has been given to a text box of that application. In some implementations, additional or different instruction blocks, such as the instruction block 1060 (represented by the variable “Z” in FIG. 10B), may additionally or alternatively be included among the actions that are performed if the conditions specified by the instruction 1054 are met, so as to enable selective pasting of data from the private clipboard 110/second clipboard 708 to other types of input elements of a requesting application 104, 704. In some implementations, the instruction block(s) 1058, 1060 may thus cause the performance of the steps B8 and B9 illustrated in FIG. 1B and/or the step 810 of the routine 800 shown in FIG. 8.

### H. Example Implementations of Methods, Systems, and Computer-Readable Media in Accordance with the Present Disclosure

The following paragraphs (M1) through (M12) describe examples of methods that may be implemented in accordance with the present disclosure.
(M1) A method may be performed that involves determining, by a first application, that a first operating system received a first input indicating that first data of a second application is to be copied to a first clipboard associated with the first operating system; determining, by the first application, that the second application is associated with a second clipboard; instructing, by the first application, the first operating system to refrain from transferring the first data to the first clipboard; receiving, by the first application, the first data from the first operating system; and transferring, by the first application, the first data to the second clipboard.
(M2) A method may be performed as described in paragraph (M1), wherein determining that the second application is associated with the second clipboard may further involve determining that the second application is associated with a first region of the second clipboard; and transferring the first data to the second clipboard may further involve transferring the first data to the first region of the second clipboard.
(M3) A method may be performed as described in paragraph (M2), and may further involve determining, by the first application, that the first operating system received a second input indicating that second data of a third application is to be copied to the first clipboard; determining, by the first application, that the third application is associated with a second region of the second clipboard; instructing, by the first application, the first operating system to refrain from transferring the second data to the first clipboard; receiving, by the first application, the second data from the first operating system; and transferring, by the first application, the second data to the second region of the second clipboard.
(M4) A method may be performed as described in paragraph (M3), and may further involve determining, by the first application, that the first operating system received a third input indicating that third data is to be pasted from the first clipboard to a fourth application which has been given focus; determining, by the first application, that the fourth application is associated with the first region of the second clipboard; instructing, by the first application, the first operating system to refrain from transferring the third data from the first clipboard to the fourth application; retrieving, by the first application, the first data from the first region of the second clipboard; and instructing, by the first application, the first operating system to transfer the first data to the fourth application.
(M5) A method may be performed as described in any of paragraphs (M2) through (M4), and may further involve determining, by the first application, that the first operating system received a second input indicating that second data is to be pasted from the first clipboard to a third application which has been given focus; determining, by the first application, that the third application is associated with the first region of the second clipboard; instructing, by the first application, the first operating system to refrain from transferring the second data from the first clipboard to the third application; retrieving, by the first application, the first data from the first region of the second clipboard; and instructing, by the first application, the first operating system to transfer the first data to the third application.
(M6) A method may be performed as described in any of paragraphs (M2) through (M5), wherein determining that the second application is associated with the first region of the second clipboard may further involve determining, by the first application, that an identifier of the second application is stored in association with an identifier of the first region.
(M7) A method may be performed as described in any of paragraphs (M1) through (M6), and may further involve determining, by the first application, that the first operating system received a second input indicating that second data is to be pasted from the first clipboard to a third application which has been given focus; determining, by the first application, that the third application is associated with the second clipboard; instructing, by the first application, the first operating system to refrain from transferring the second data from the first clipboard to the third application; retrieving, by the first application, the first data from the second clipboard; and instructing, by the first application, the first operating system to transfer the first data to the third application.
(M8) A method may be performed as described in any of paragraphs (M1) through (M7), wherein the first operating system and the first application may be executed by at least one first processor of a first computing system; a second operating system and a third application may be executed by at least one second processor of a second computing system that communicates with the first computing system over a network; and the method may further involve transferring, via the network, the first data from the second clipboard to a third clipboard of the second computing system; determining, by the third application, that the second operating system received a second input indicating that second data is to be pasted from a fourth clipboard associated with the second operating system to a fourth application which has been given focus; determining, by the third application, that the fourth application is associated with the third clipboard; instructing, by the third application, the second operating system to refrain from transferring the second data from the fourth clipboard to the fourth application; retrieving, by the third application, the first data from the third clipboard; and instructing, by the third application, the second operating system to transfer the first data to the fourth application.
(M9) A method may be performed that involves determining, by a first application, that that an operating system received a first input indicating that first data is to be pasted from a first clipboard associated with the operating system to a second application which has been given focus; determining, by the first application, that the second application is associated with a second clipboard, the second clipboard including second data; instructing, by the first application, the operating system to refrain from transferring the first data from the first clipboard to the second application; retrieving, by the first application, the second data from the second clipboard; and instructing, by the first application, the operating system to transfer the second data to the second application.
(M10) A method may be performed as described in paragraph (M9), wherein determining that the second application is associated with the second clipboard may further involve determining that the second application is associated with a first region of the second clipboard; and retrieving the second data from the second clipboard may further involve retrieving the second data from the first region of the second clipboard.
(M11) A method may be performed as described in paragraph (M10), and may further involve determining, by the first application, that that the operating system received a second input indicating that third data is to be pasted from the first clipboard to a third application which has been given focus; determining, by the first application, that the third application is associated with a second region of the second clipboard, the second region including fourth data; instructing, by the first application, the operating system to refrain from transferring the third data from the first clipboard to the third application; retrieving, by the first application, the fourth data from the second region of the second clipboard; and instructing, by the first application, the operating system to transfer the fourth data to the third application.
(M12) A method may be performed as described in paragraph (M10) or paragraph (M11), wherein determining that the second application is associated with the first region of the second clipboard may further involve determining, by the first application, that an identifier of the second application is stored in association with an identifier of the first region.

The following paragraphs (S1) through (S12) describe examples of systems and devices that may be implemented in accordance with the present disclosure.
(S1) A first computing system may include at least one first processor, and at least one first computer-readable medium encoded with instructions which, when executed by the at least one first processor, cause the first computing system to determine, by a first application, that a first operating system received a first input indicating that first data of a second application is to be copied to a first clipboard associated with the first operating system, to determine, by the first application, that the second application is associated with a second clipboard, to instruct, by the first application, the first operating system to refrain from transferring the first data to the first clipboard, to receive, by the first application, the first data from the first operating system, and to transfer, by the first application, the first data to the second clipboard.
(S2) A first computing system may be configured as described in paragraph (S1), and the at least one first computer-readable medium may be further encoded with additional instructions which, when executed by the at least one first processor, further cause the first computing system to determine that the second application is associated with the second clipboard at least in part by determining that the second application is associated with a first region of the second clipboard, and to transfer the first data to the second clipboard at least in part by transferring the first data to the first region of the second clipboard.
(S3) A first computing system may be configured as described in paragraph (S2), and the at least one first computer-readable medium may be further encoded with additional instructions which, when executed by the at least one first processor, further cause the first computing system to determine, by the first application, that the first operating system received a second input indicating that second data of a third application is to be copied to the first clipboard, to determine, by the first application, that the third application is associated with a second region of the second clipboard, to instruct, by the first application, the first operating system to refrain from transferring the second data to the first clipboard, to receive, by the first application, the second data from the first operating system, and to transfer, by the first application, the second data to the second region of the second clipboard.
(S4) A first computing system may be configured as described in paragraph (S3), and the at least one first computer-readable medium may be further encoded with additional instructions which, when executed by the at least one first processor, further cause the first computing system to determine, by the first application, that the first operating system received a third input indicating that third data is to be pasted from the first clipboard to a fourth application which has been given focus, to determine, by the first application, that the fourth application is associated with the first region of the second clipboard, to instruct, by the first application, the first operating system to refrain from transferring the third data from the first clipboard to the fourth application, to retrieve, by the first application, the first data from the first region of the second clipboard, and to instruct, by the first application, the first operating system to transfer the first data to the fourth application.
(S5) A first computing system may be configured as described in any of paragraphs (S2) through (S4), and the at least one first computer-readable medium may be further encoded with additional instructions which, when executed by the at least one first processor, further cause the first computing system to determine, by the first application, that the first operating system received a second input indicating that second data is to be pasted from the first clipboard to a third application which has been given focus, to determine, by the first application, that the third application is associated with the first region of the second clipboard, to instruct, by the first application, the first operating system to refrain from transferring the second data from the first clipboard to the third application, to retrieve, by the first application, the first data from the first region of the second clipboard, and to instruct, by the first application, the first operating system to transfer the first data to the third application.
(S6) A first computing system may be configured as described in any of paragraphs (S2) through (S5), and the at least one first computer-readable medium may be further encoded with additional instructions which, when executed by the at least one first processor, further cause the first computing system to determine that the second application is associated with the first region of the second clipboard at least in part by determining, by the first application, that an identifier of the second application is stored in association with an identifier of the first region.
(S7) A first computing system may be configured as described in any of paragraphs (S1) through (S6), and the at least one first computer-readable medium may be further encoded with additional instructions which, when executed by the at least one first processor, further cause the first computing system to determine, by the first application, that the first operating system received a second input indicating that second data is to be pasted from the first clipboard to a third application which has been given focus, to determine, by the first application, that the third application is associated with the second clipboard, to instruct, by the first application, the first operating system to refrain from transferring the second data from the first clipboard to the third application, to retrieve, by the first application, the first data from the second clipboard, and to instruct, by the first application, the first operating system to transfer the first data to the third application.
(S8) A system may include a first computing system configured as described in any of paragraphs (S1) through (S7), in combination with a second computing system configured to communicate with the first computing system over a network, the second computing system comprising at least one second processor and at least one second computer-readable medium encoded with instructions which, when executed by the at least one second processor, cause the second computing system to receive the first data from the second clipboard via the network, to store the first data in a third clipboard, to determine, by a third application, that a second operating system received a second input indicating that second data is to be pasted from a fourth clipboard associated with the second operating system to a fourth application which has been given focus, to determine, by the third application, that the fourth application is associated with the third clipboard, to instruct, by the third application, the second operating system to refrain from transferring the second data from the fourth clipboard to the fourth application, to retrieve, by the third application, the first data from the third clipboard, and to instruct, by the third application, the second operating system to transfer the first data to the fourth application.
(S9) A computing system may include at least one processor, and at least one computer-readable medium encoded with instructions which, when executed by the at least one processor, cause the computing system to determine, by a first application, that that an operating system received a first input indicating that first data is to be pasted from a first clipboard associated with the operating system to a second application which has been given focus, to determine, by the first application, that the second application is associated with a second clipboard, the second clipboard including second data, to instruct, by the first application, the operating system to refrain from transferring the first data from the first clipboard to the second application, to retrieve, by the first application, the second data from the second clipboard, and to instruct, by the first application, the operating system to transfer the second data to the second application.
(S10) A computing system may be configured as described in paragraph (S9), and the at least one computer-readable medium may be further encoded with additional instructions which, when executed by the at least one processor, further cause the computing system to determine that the second application is associated with the second clipboard at least in part by determining that the second application is associated with a first region of the second clipboard, and to retrieve the second data from the second clipboard at least in part by retrieving the second data from the first region of the second clipboard.
(S11) A computing system may be configured as described in paragraph (S10), and the at least one computer-readable medium may be further encoded with additional instructions which, when executed by the at least one processor, further cause the computing system to determine, by the first application, that that the operating system received a second input indicating that third data is to be pasted from the first clipboard to a third application which has been given focus, to determine, by the first application, that the third application is associated with a second region of the second clipboard, the second region including fourth data, to instruct, by the first application, the operating system to refrain from transferring the third data from the first clipboard to the third application, to retrieve, by the first application, the fourth data from the second region of the second clipboard, and to instruct, by the first application, the operating system to transfer the fourth data to the third application.
(S12) A computing system may be configured as described in paragraph (S10) or paragraph (S11), and the at least one computer-readable medium may be further encoded with additional instructions which, when executed by the at least one processor, further cause the computing system to determine that the second application is associated with the first region of the second clipboard at least in part by determining, by the first application, that an identifier of the second application is stored in association with an identifier of the first region.

The following paragraphs (CRM1) through (CRM12) describe examples of computer-readable media that may be implemented in accordance with the present disclosure.
(CRM1) At least one first non-transitory computer-readable medium may be encoded with instructions which, when executed by the at least one first processor of a first computing system, cause the first computing system to determine, by a first application, that a first operating system received a first input indicating that first data of a second application is to be copied to a first clipboard associated with the first operating system, to determine, by the first application, that the second application is associated with a second clipboard, to instruct, by the first application, the first operating system to refrain from transferring the first data to the first clipboard, to receive, by the first application, the first data from the first operating system, and to transfer, by the first application, the first data to the second clipboard.
(CRM2) At least one first non-transitory computer-readable medium may be configured as described in paragraph (CRM1), and may be further encoded with additional instructions which, when executed by the at least one first processor, further cause the first computing system to determine that the second application is associated with the second clipboard at least in part by determining that the second application is associated with a first region of the second clipboard, and to transfer the first data to the second clipboard at least in part by transferring the first data to the first region of the second clipboard.
(CRM3) At least one first non-transitory computer-readable medium may be configured as described in paragraph (CRM2), and may be further encoded with additional instructions which, when executed by the at least one first processor, further cause the first computing system to determine, by the first application, that the first operating system received a second input indicating that second data of a third application is to be copied to the first clipboard, to determine, by the first application, that the third application is associated with a second region of the second clipboard, to instruct, by the first application, the first operating system to refrain from transferring the second data to the first clipboard, to receive, by the first application, the second data from the first operating system, and to transfer, by the first application, the second data to the second region of the second clipboard.
(CRM4) At least one first non-transitory computer-readable medium may be configured as described in paragraph (CRM3), and may be further encoded with additional instructions which, when executed by the at least one first processor, further cause the first computing system to determine, by the first application, that the first operating system received a third input indicating that third data is to be pasted from the first clipboard to a fourth application which has been given focus, to determine, by the first application, that the fourth application is associated with the first region of the second clipboard, to instruct, by the first application, the first operating system to refrain from transferring the third data from the first clipboard to the fourth application, to retrieve, by the first application, the first data from the first region of the second clipboard, and to instruct, by the first application, the first operating system to transfer the first data to the fourth application.
(CRM5) At least one first non-transitory computer-readable medium may be configured as described in any of paragraphs (CRM2) through (CRM4), and may be further encoded with additional instructions which, when executed by the at least one first processor, further cause the first computing system to determine, by the first application, that the first operating system received a second input indicating that second data is to be pasted from the first clipboard to a third application which has been given focus, to determine, by the first application, that the third application is associated with the first region of the second clipboard, to instruct, by the first application, the first operating system to refrain from transferring the second data from the first clipboard to the third application, to retrieve, by the first application, the first data from the first region of the second clipboard, and to instruct, by the first application, the first operating system to transfer the first data to the third application.
(CRM6) At least one first non-transitory computer-readable medium may be configured as described in any of paragraphs (CRM2) through (CRM5), and may be further encoded with additional instructions which, when executed by the at least one first processor, further cause the first computing system to determine that the second application is associated with the first region of the second clipboard at least in part by determining, by the first application, that an identifier of the second application is stored in association with an identifier of the first region.
(CRM7) At least one first non-transitory computer-readable medium may be configured as described in any of paragraphs (CRM1) through (CRM6), and may be further encoded with additional instructions which, when executed by the at least one first processor, further cause the first computing system to determine, by the first application, that the first operating system received a second input indicating that second data is to be pasted from the first clipboard to a third application which has been given focus, to determine, by the first application, that the third application is associated with the second clipboard, to instruct, by the first application, the first operating system to refrain from transferring the second data from the first clipboard to the third application, to retrieve, by the first application, the first data from the second clipboard, and to instruct, by the first application, the first operating system to transfer the first data to the third application.
(CRM8) A system may include at least one first non-transitory computer-readable medium configured as described in any of paragraphs (CRM1) through (CRM7), in combination with at least one second non-transitory computer-readable medium encoded with additional instructions which, when executed by the at least one second processor of a second computing system, cause the second computing system to receive the first data from the second clipboard via a network, to store the first data in a third clipboard, to determine, by a third application, that a second operating system received a second input indicating that second data is to be pasted from a fourth clipboard associated with the second operating system to a fourth application which has been given focus, to determine, by the third application, that the fourth application is associated with the third clipboard, to instruct, by the third application, the second operating system to refrain from transferring the second data from the fourth clipboard to the fourth application, to retrieve, by the third application, the first data from the third clipboard, and to instruct, by the third application, the second operating system to transfer the first data to the fourth application.
(CRM9) At least one non-transitory computer-readable medium may be encoded with instructions which, when executed by the at least one processor of a computing system, cause the computing system to determine, by a first application, that that an operating system received a first input indicating that first data is to be pasted from a first clipboard associated with the operating system to a second application which has been given focus, to determine, by the first application, that the second application is associated with a second clipboard, the second clipboard including second data, to instruct, by the first application, the operating system to refrain from transferring the first data from the first clipboard to the second application, to retrieve, by the first application, the second data from the second clipboard, and to instruct, by the first application, the operating system to transfer the second data to the second application.
(CRM10) At least one non-transitory computer-readable medium may be configured as described in paragraph (CRM9), and may be further encoded with additional instructions which, when executed by the at least one processor, further cause the computing system to determine that the second application is associated with the second clipboard at least in part by determining that the second application is associated with a first region of the second clipboard, and to retrieve the second data from the second clipboard at least in part by retrieving the second data from the first region of the second clipboard.
(CRM11) At least one non-transitory computer-readable medium may be configured as described in paragraph (CRM10), and may be further encoded with additional instructions which, when executed by the at least one processor, further cause the computing system to determine, by the first application, that that the operating system received a second input indicating that third data is to be pasted from the first clipboard to a third application which has been given focus, to determine, by the first application, that the third application is associated with a second region of the second clipboard, the second region including fourth data, to instruct, by the first application, the operating system to refrain from transferring the third data from the first clipboard to the third application, to retrieve, by the first application, the fourth data from the second region of the second clipboard, and to instruct, by the first application, the operating system to transfer the fourth data to the third application.
(CRM12) At least one non-transitory computer-readable medium may be configured as described in paragraph (CRM10) or paragraph (CRM11), and may be further encoded with additional instructions which, when executed by the at least one processor, further cause the computing system to determine that the second application is associated with the first region of the second clipboard at least in part by determining, by the first application, that an identifier of the second application is stored in association with an identifier of the first region.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
determining, by a first application, that a first operating system received a first input indicating that first data of a second application is to be copied to a first clipboard associated with the first operating system;
determining, by the first application, that the second application is associated with a second clipboard;
instructing, by the first application, the first operating system to refrain from transferring the first data to the first clipboard;
receiving, by the first application, the first data from the first operating system; and
transferring, by the first application, the first data to the second clipboard.

2. The method of claim 1, wherein:
determining that the second application is associated with the second clipboard further comprises determining that the second application is associated with a first region of the second clipboard; and
transferring the first data to the second clipboard further comprises transferring the first data to the first region of the second clipboard.

3. The method of claim 2, further comprising:
determining, by the first application, that the first operating system received a second input indicating that second data of a third application is to be copied to the first clipboard;
determining, by the first application, that the third application is associated with a second region of the second clipboard;
instructing, by the first application, the first operating system to refrain from transferring the second data to the first clipboard;
receiving, by the first application, the second data from the first operating system; and
transferring, by the first application, the second data to the second region of the second clipboard.

4. The method of claim 3, further comprising:
determining, by the first application, that the first operating system received a third input indicating that third data is to be pasted from the first clipboard to a fourth application which has been given focus;
determining, by the first application, that the fourth application is associated with the first region of the second clipboard;
instructing, by the first application, the first operating system to refrain from transferring the third data from the first clipboard to the fourth application;
retrieving, by the first application, the first data from the first region of the second clipboard; and
instructing, by the first application, the first operating system to transfer the first data to the fourth application.

5. The method of claim 2, further comprising:
determining, by the first application, that the first operating system received a second input indicating that second data is to be pasted from the first clipboard to a third application which has been given focus;
determining, by the first application, that the third application is associated with the first region of the second clipboard;
instructing, by the first application, the first operating system to refrain from transferring the second data from the first clipboard to the third application;
retrieving, by the first application, the first data from the first region of the second clipboard; and
instructing, by the first application, the first operating system to transfer the first data to the third application.

6. The method of claim 2, wherein determining that the second application is associated with the first region of the second clipboard further comprises:
determining, by the first application, that an identifier of the second application is stored in association with an identifier of the first region.

7. The method of claim 1, further comprising:
determining, by the first application, that the first operating system received a second input indicating that second data is to be pasted from the first clipboard to a third application which has been given focus;
determining, by the first application, that the third application is associated with the second clipboard;
instructing, by the first application, the first operating system to refrain from transferring the second data from the first clipboard to the third application;
retrieving, by the first application, the first data from the second clipboard; and
instructing, by the first application, the first operating system to transfer the first data to the third application.

8. The method of claim 1, wherein:
the first operating system and the first application are executed by at least one first processor of a first computing system;
a second operating system and a third application are executed by at least one second processor of a second computing system that communicates with the first computing system over a network; and
the method further comprises:
transferring, via the network, the first data from the second clipboard to a third clipboard of the second computing system;
determining, by the third application, that the second operating system received a second input indicating that second data is to be pasted from a fourth clipboard associated with the second operating system to a fourth application which has been given focus;
determining, by the third application, that the fourth application is associated with the third clipboard;
instructing, by the third application, the second operating system to refrain from transferring the second data from the fourth clipboard to the fourth application;
retrieving, by the third application, the first data from the third clipboard; and
instructing, by the third application, the second operating system to transfer the first data to the fourth application.

9. A method, comprising:
determining, by a first application, that that an operating system received a first input indicating that first data is to be pasted from a first clipboard associated with the operating system to a second application which has been given focus;
determining, by the first application, that the second application is associated with a second clipboard, the second clipboard including second data;
instructing, by the first application, the operating system to refrain from transferring the first data from the first clipboard to the second application;
retrieving, by the first application, the second data from the second clipboard; and
instructing, by the first application, the operating system to transfer the second data to the second application.

10. The method of claim 9, wherein:
determining that the second application is associated with the second clipboard further comprises determining that the second application is associated with a first region of the second clipboard; and
retrieving the second data from the second clipboard further comprises retrieving the second data from the first region of the second clipboard.

11. The method of claim 10, further comprising:
determining, by the first application, that that the operating system received a second input indicating that third data is to be pasted from the first clipboard to a third application which has been given focus;
determining, by the first application, that the third application is associated with a second region of the second clipboard, the second region including fourth data;
instructing, by the first application, the operating system to refrain from transferring the third data from the first clipboard to the third application;
retrieving, by the first application, the fourth data from the second region of the second clipboard; and
instructing, by the first application, the operating system to transfer the fourth data to the third application.

12. The method of claim 10, wherein determining that the second application is associated with the first region of the second clipboard further comprises:
determining, by the first application, that an identifier of the second application is stored in association with an identifier of the first region.

13. A first computing system, comprising:
at least one first processor; and
at least one first computer-readable medium encoded with instructions which, when executed by the at least one first processor, cause the first computing system to:
determine, by a first application, that a first operating system received a first input indicating that first data of a second application is to be copied to a first clipboard associated with the first operating system;
determine, by the first application, that the second application is associated with a second clipboard;
instruct, by the first application, the first operating system to refrain from transferring the first data to the first clipboard;
receive, by the first application, the first data from the first operating system; and
transfer, by the first application, the first data to the second clipboard.

14. The first computing system of claim 13, wherein the at least one first computer-readable medium is further encoded with additional instructions which, when executed by the at least one first processor, further cause the first computing system to:
determine that the second application is associated with a first region of the second clipboard; and
transfer the first data to the first region of the second clipboard.

15. The first computing system of claim 14, wherein the at least one first computer-readable medium is further encoded with additional instructions which, when executed by the at least one first processor, further cause the first computing system to:
determine, by the first application, that the first operating system received a second input indicating that second data of a third application is to be copied to the first clipboard;
determine, by the first application, that the third application is associated with a second region of the second clipboard;
instruct, by the first application, the first operating system to refrain from transferring the second data to the first clipboard;
receive, by the first application, the second data from the first operating system; and
transfer, by the first application, the second data to the second region of the second clipboard.

16. The first computing system of claim 15, wherein the at least one first computer-readable medium is further encoded with additional instructions which, when executed by the at least one first processor, further cause the first computing system to:
determine, by the first application, that the first operating system received a third input indicating that third data is to be pasted from the first clipboard to a fourth application which has been given focus;
determine, by the first application, that the fourth application is associated with the first region of the second clipboard;
instruct, by the first application, the first operating system to refrain from transferring the third data from the first clipboard to the fourth application;
retrieve, by the first application, the first data from the first region of the second clipboard; and
instruct, by the first application, the first operating system to transfer the first data to the fourth application.

17. The first computing system of claim 14, wherein the at least one first computer-readable medium is further encoded with additional instructions which, when executed by the at least one first processor, further cause the first computing system to:
determine, by the first application, that the first operating system received a second input indicating that second data is to be pasted from the first clipboard to a third application which has been given focus;
determine, by the first application, that the third application is associated with the first region of the second clipboard;
instruct, by the first application, the first operating system to refrain from transferring the second data from the first clipboard to the third application;
retrieve, by the first application, the first data from the first region of the second clipboard; and
instruct, by the first application, the first operating system to transfer the first data to the third application.

18. The first computing system of claim 14, wherein the at least one first computer-readable medium is further encoded with additional instructions which, when executed by the at least one first processor, further cause the first computing system to:
determine that the second application is associated with the first region of the second clipboard at least in part by determining, by the first application, that an identifier of the second application is stored in association with an identifier of the first region.

19. The first computing system of claim 13, wherein the at least one first computer-readable medium is further encoded with additional instructions which, when executed by the at least one first processor, further cause the first computing system to:
determine by the first application, that the first operating system received a second input indicating that second data is to be pasted from the first clipboard to a third application which has been given focus;
determine, by the first application, that the third application is associated with the second clipboard;
instruct, by the first application, the first operating system to refrain from transferring the second data from the first clipboard to the third application;
retrieve, by the first application, the first data from the second clipboard; and
instruct, by the first application, the first operating system to transfer the first data to the third application.

20. The first computing system of claim 13, in combination with a second computing system configured to communicate with the first computing system over a network, the second computing system comprising at least one second processor and at least one second computer-readable medium encoded with instructions which, when executed by the at least one second processor, cause the second computing system to:
receive the first data from the second clipboard via the network;
store the first data in a third clipboard;
determine, by a third application, that a second operating system received a second input indicating that second data is to be pasted from a fourth clipboard associated with the second operating system to a fourth application which has been given focus;
determine, by the third application, that the fourth application is associated with the third clipboard;
instruct, by the third application, the second operating system to refrain from transferring the second data from the fourth clipboard to the fourth application;
retrieve, by the third application, the first data from the third clipboard; and
instruct, by the third application, the second operating system to transfer the first data to the fourth application.
